(19) United States
(12) Patent Application Publication
(10) Pub. No.: US 2024/0013658 A1
(43) Pub. Date: Jan. 11, 2024

(54) PROCESSING METHOD, PROCESSING SYSTEM AND STORAGE MEDIUM STORING PROCESSING PROGRAM

(71) Applicant: DENSO CORPORATION, Kariya-city (JP)

(72) Inventors: HIDENORI MATSUZAKI, Kariya-city (JP); HIROTOSHI YASUOKA, Kariya-city (JP)

(21) Appl. No.: 18/472,945

(22) Filed: Sep. 22, 2023

Related U.S. Application Data
(63) Continuation of application No. PCT/JP2022/006439, filed on Feb. 17, 2022.

(30) Foreign Application Priority Data
Mar. 26, 2021 (JP) 2021-053970

(51) Int. Cl. G08G 1/16; G08G 1/09

(52) U.S. Cl. CPC G08G 1/16; G08G 1/09

(57) ABSTRACT

In one aspect, a processing method is executed by a processor to perform processing related to driving of a host moving object that is configured to communicate with a target moving object. The processing method includes: monitoring an envelope violation that is a violation of a safety envelope in which safety of intended functionality is set in the host moving object with respect to another road user other than the target moving object; and generating, when the envelope violation is recognized in the host moving object, warning information for warning of the envelope violation that is to be transmitted to the target moving object.

### CROSS REFERENCE TO RELATED APPLICATIONS

This application is a continuation application of International Patent Application No. PCT/JP2022/006439 filed on Feb. 17, 2022, which designated the U.S. and claims the benefit of priority from Japanese Patent Application No. 2021-053970 filed on Mar. 26, 2021. The entire disclosure of all of the above application is incorporated herein by reference.

### TECHNICAL FIELD

The present disclosure relates to a processing technique for performing processing related to driving of a moving object.

### BACKGROUND ART

There has been known driving control related to a navigation operation of a host vehicle is planned according to detection information related to internal and external environments of the host vehicle. Therefore, when it is determined that there is potential accident responsibility based on a safety model following a driving policy and the detection information, a constraint is given to the driving control.

### SUMMARY

According to one aspect of the present disclosure, a processing method is executed by a processor to perform processing related to driving of a host moving object that is configured to communicate with a target moving object. The processing method includes: monitoring an envelope violation that is a violation of a safety envelope in which safety of intended functionality is set in the host moving object with respect to another road user other than the target moving object; and generating, when the envelope violation is recognized in the host moving object, warning information for warning of the envelope violation that is to be transmitted to the target moving object.

### BRIEF DESCRIPTION OF DRAWINGS

FIG. 1 is a table illustrating explanations of terms in the present disclosure.

FIG. 2 is a table illustrating explanations of terms in the present disclosure.

FIG. 3 is a table illustrating explanations of terms in the present disclosure.

FIG. 4 is a table illustrating explanations of terms in the present disclosure.

FIG. 5 is a table illustrating explanations of terms in the present disclosure.

FIG. 6 is a block diagram illustrating a processing system according to a first embodiment.

FIG. 7 is a schematic diagram illustrating a traveling environment of a host vehicle to which the first embodiment is applied.

FIG. 8 is a schematic diagram illustrating a traveling environment of the host vehicle to which the first embodiment is applied.

FIG. 9 is a block diagram illustrating the processing system according to the first embodiment.

FIG. 10 is a schematic diagram illustrating a lane structure example and a processing method according to the first embodiment.

FIG. 11 is a schematic diagram illustrating a lane structure example and a processing method according to the first embodiment.

FIG. 12 is a schematic diagram illustrating a lane structure example and a processing method according to the first embodiment.

FIG. 13 is a schematic diagram illustrating a lane structure example and a processing method according to the first embodiment.

FIG. 14 is a schematic diagram illustrating a lane structure example and a processing method according to the first embodiment.

FIG. 15 is a schematic diagram illustrating a lane structure example and a processing method according to the first embodiment.

FIG. 16 is a flowchart illustrating the processing method according to the first embodiment.

FIG. 17 is a flowchart illustrating the processing method according to the first embodiment.

FIG. 18 is a flowchart illustrating a processing method according to a second embodiment.

FIG. 19 is a flowchart illustrating the processing method according to the second embodiment.

FIG. 20 is a block diagram illustrating a processing system according to a third embodiment.

FIG. 21 is a block diagram illustrating a processing system according to a fourth embodiment.

FIG. 22 is a block diagram illustrating a processing system according to a fifth embodiment.

FIG. 23 is a block diagram illustrating a processing system according to a sixth embodiment.

FIG. 24 is a block diagram illustrating the processing system according to the sixth embodiment.

### DESCRIPTION OF EMBODIMENTS

To begin with, a relevant technology will be described first only for understanding the following embodiments.

In a typical driving control technology, it is assumed that, even when another road user other than a target vehicle is detected from the host vehicle, the other road user is shield by the host vehicle and is difficult to be detected from the target vehicle. In this case, a response with respect to the other road user may be affected.

One of objectives of the present disclosure is to provide a processing method for promoting improvement of a response capability with respect to the other road user. Another object of the present disclosure is to provide a processing system for promoting the improvement of the response capability with respect to the other road user. Still another object of the present disclosure is to provide a processing program for promoting the improvement of the response capability with respect to the other road user.

In a first aspect of the present disclosure, a processing method is executed by a processor to perform processing related to driving of a host moving object that is configured to communicate with a target moving object. The processing method includes: monitoring an envelope violation that is a violation of a safety envelope in which safety of intended functionality is set in the host moving object with respect to another road user other than the target moving object; and generating, when the envelope violation is recognized in the host moving object, warning information for warning of the envelope violation that is to be transmitted to the target moving object.

In a second aspect of the present disclosure, a processing system performs processing related to driving of a host moving object configured to communicate with a target moving object. The processing system includes a processor configured to: monitor an envelope violation that is a violation of a safety envelope in which safety of intended functionality is set in the host moving object with respect to another road user other than the target moving object; and generate, when the envelope violation is recognized in the host moving object, warning information for warning of the envelope violation that is to be transmitted to the target moving object.

In a third aspect of the present disclosure, a non-transitory, computer readable, tangible storage medium stores a processing program. The processing program includes an instruction, when executed by a processor, causing the processor to perform processing related to driving of a host moving object that is configured to communicate with a target moving object. The instruction includes: monitoring an envelope violation that is a violation of a safety envelope in which safety of intended functionality is set in the host moving object with respect to another road user other than the target moving object; and generating, when the envelope violation is recognized in the host moving object, warning information for warning of the envelope violation that is to be transmitted to the target moving object.

In host moving objects according to first to third aspects, an envelope that is a violation of a safety envelope in which safety of the intended functionality is set with respect to another road user other than a target moving object is monitored. Therefore, when the envelope violation with respect to the other road user is recognized, the host moving object generates warning information for warning of the envelope violation such that the warning information is transmitted to the target moving object. Accordingly, since the envelope violation with respect to the other road user warned by the host moving object can be commonly recognized in the target moving object, it is possible to promote improvement of a response capability with respect to the other road user.

In a fourth aspect of the present disclosure, a processing method is executed by a processor to perform processing related to driving of a host moving object that is configured to communicate with a target moving object. The processing method includes: acquiring, from the target moving object, warning information for warning of an envelope violation that is a violation of a safety envelope in which safety of intended functionality is set in the target moving object with respect to another road user other than the host moving object; and determining whether the envelope violation with respect to the other road user occurs in response to acquiring the warning information.

In a fifth aspect of the present disclosure, a processing system performs processing related to driving of a host moving object configured to communicate with a target moving object. The processing system includes a processor configured to: acquire, from the target moving object, warning information for warning of an envelope violation that is a violation of a safety envelope in which safety of intended functionality is set in the target moving object with respect to another road user other than the host moving object; and determine whether the envelope violation with respect to the other road user occurs in response to acquiring the warning information.

In a sixth aspect of the present disclosure, a non-transitory, computer readable, tangible storage medium stores a processing program. The processing program includes an instruction, when executed by a processor, causing the processor to perform processing related to driving of a host moving object that is configured to communicate with a target moving object. The instruction includes: acquiring, from the target moving object, warning information for warning of an envelope violation that is a violation of a safety envelope in which safety of intended functionality is set in the target moving object with respect to another road user other than the host moving object; and determining whether the envelope violation with respect to the other road user occurs in response to acquiring the warning information.

In host moving objects according to fourth to sixth aspects, warning information for warning of an envelope violation that is a violation of a safety envelope in which safety of the intended functionality is set with respect to another road user other than a host moving object in a target moving object is acquired from the target moving object. Therefore, in response to the acquisition of the warning information, in the host moving object, presence or absence of the envelope violation with respect to the other road user is determined. Accordingly, since the envelope violation with respect to the other road user warned by the target moving object can be commonly recognized in the host moving object and can be reflected in the determination on presence or absence of the envelope violation, it is possible to promote improvement of a response capability with respect to the other road user.

Hereinafter, multiple embodiments according to the present disclosure will be described with reference to the drawings. Duplicate description may be omitted by assigning the same reference numerals to corresponding configuration elements in each embodiment. When only a part of a configuration is described in each embodiment, configurations of the other embodiments described above can be applied to the other parts of the configuration. Further, not only the combinations of the configurations explicitly specified in the description of each embodiment, but also the configurations of the multiple embodiments can be partially combined even if they are not explicitly specified unless there is a particular problem with the combinations.

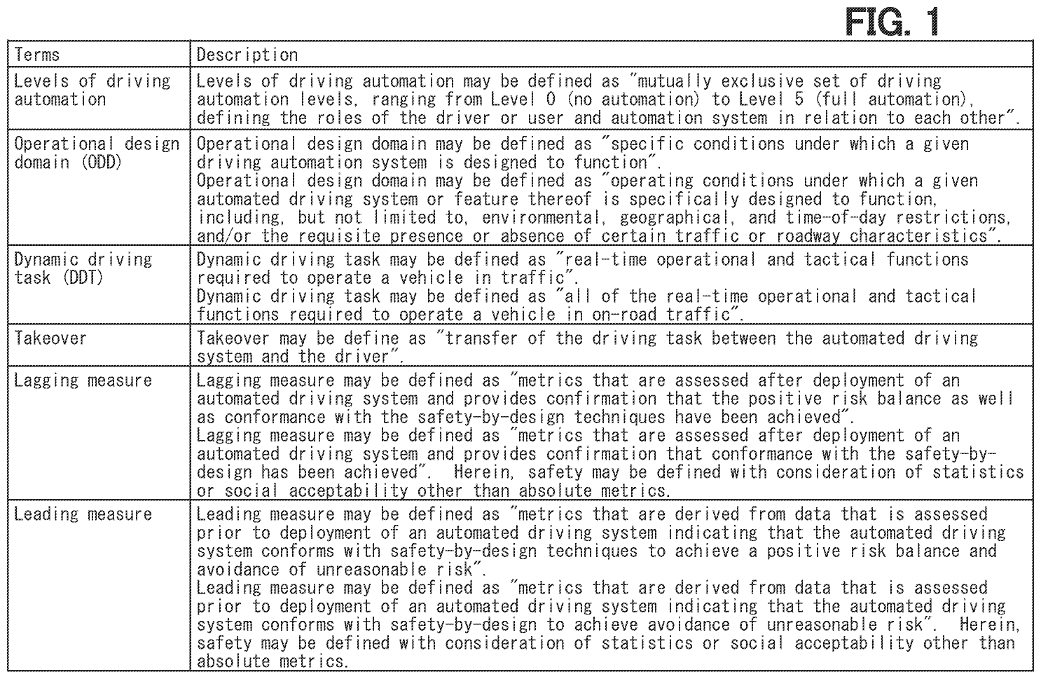

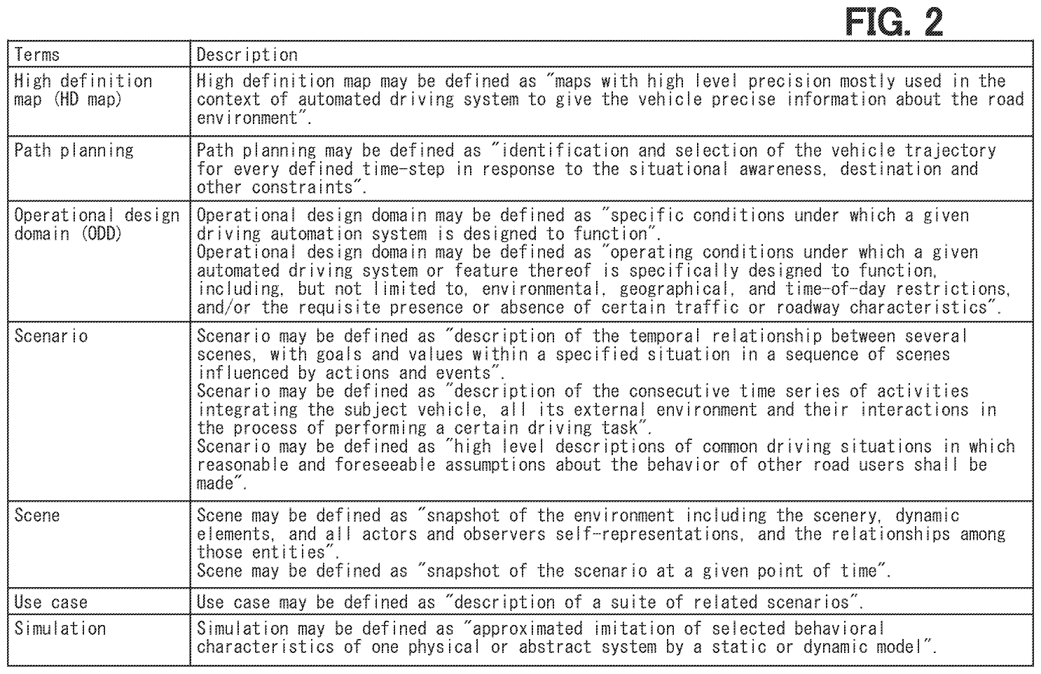

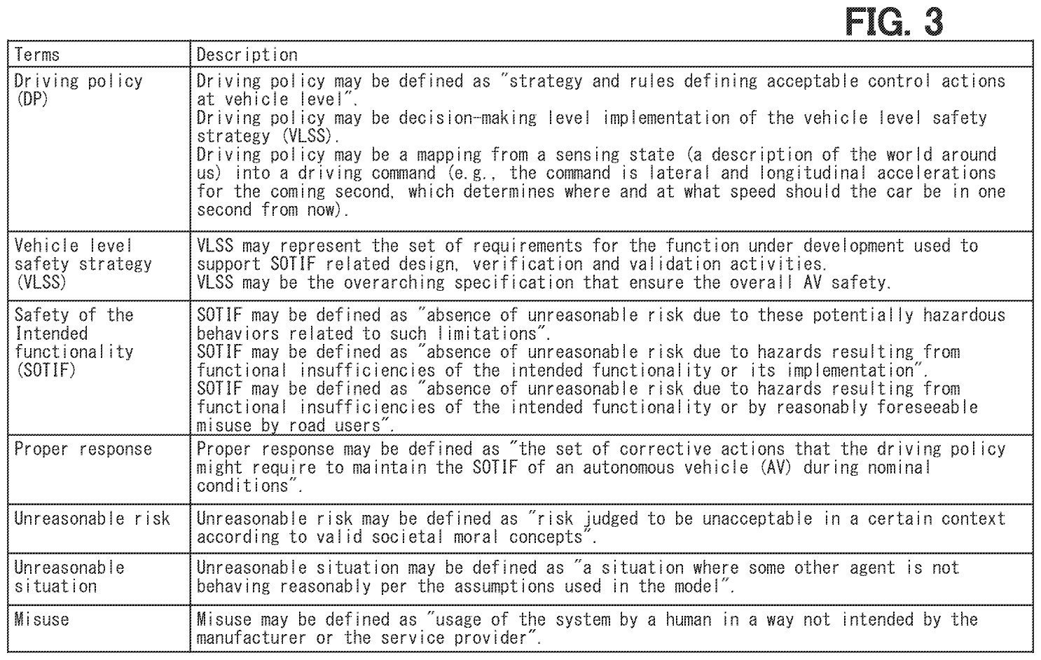

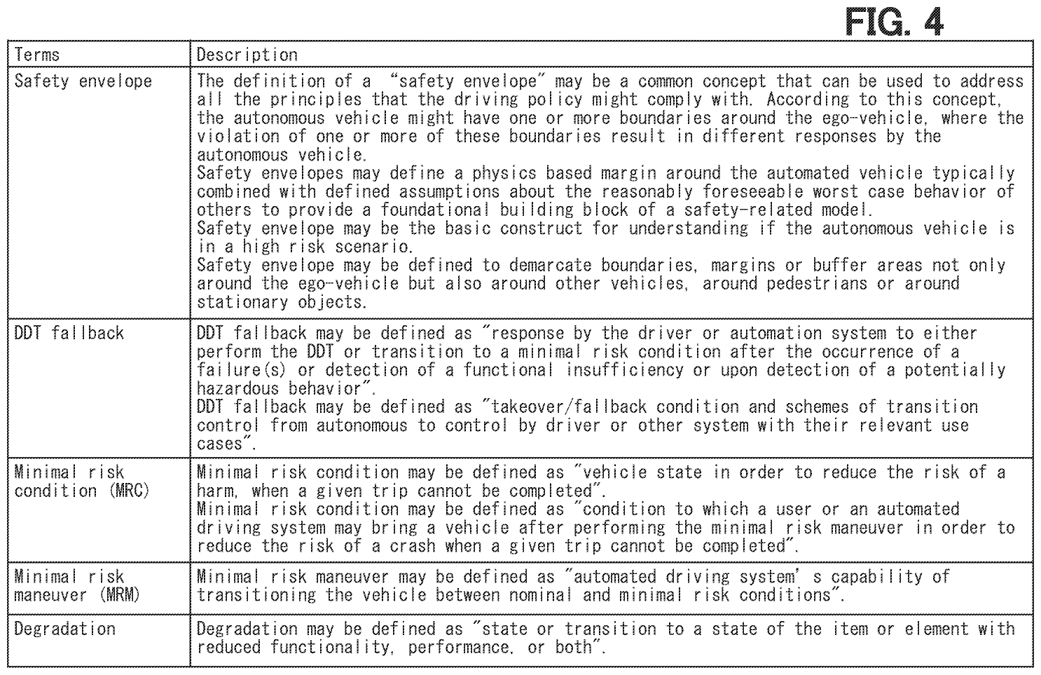

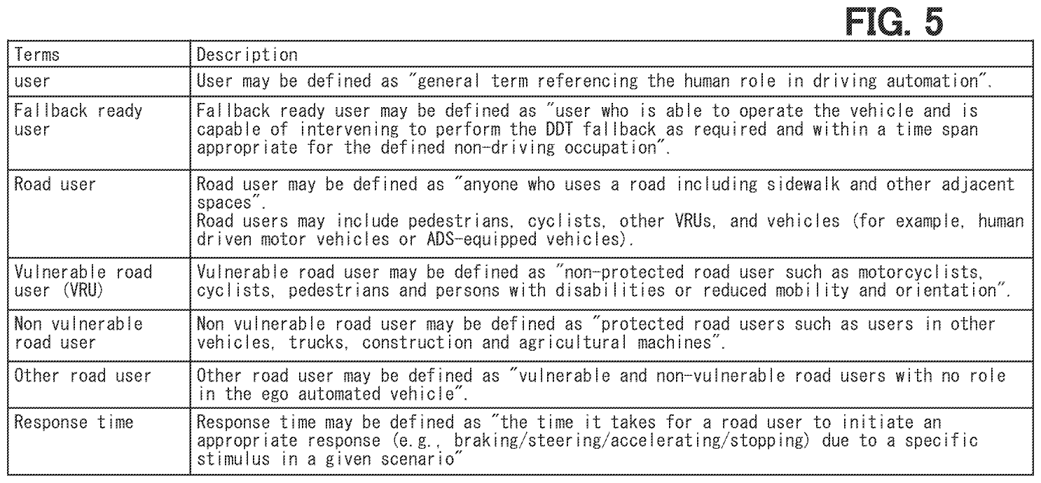

FIGS. 1 to 5 illustrate explanations of terms associated with each embodiment according to the present disclosure. However, definitions of the terms are not interpreted as being limited to the explanations illustrated in FIGS. 1 to 5, and are interpreted without departing from the gist of the present disclosure.

### First Embodiment

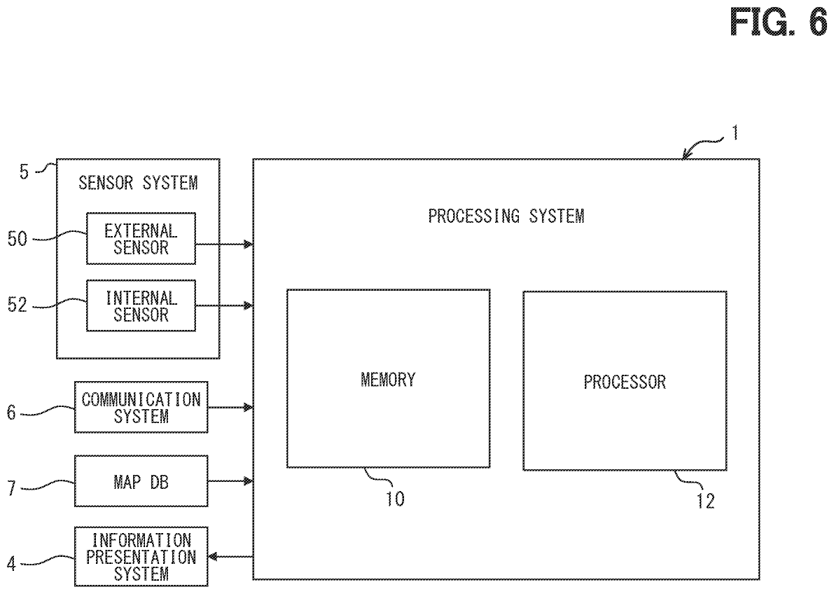

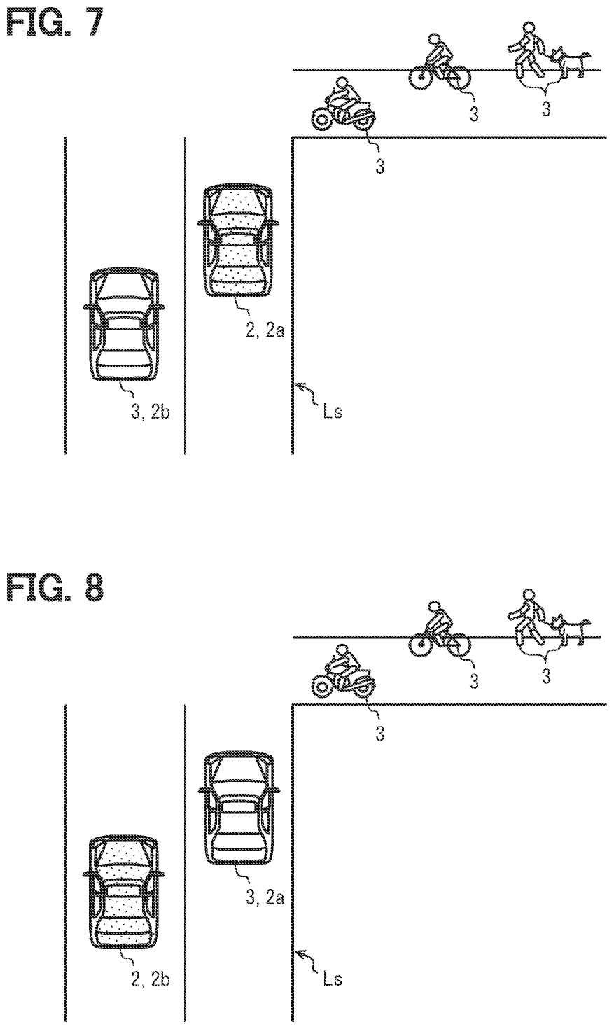

A processing system 1 according to a first embodiment illustrated in FIG. 6 performs processing related to driving of a moving object (hereinafter, referred to as driving-related processing). The moving object subjected to the driving-related processing by the processing system 1 is a vehicle 2 illustrated in FIGS. 7 and 8. In the first embodiment, as the vehicle 2 to which the processing system 1 is applied, a first vehicle 2a and a second vehicle 2b that can communicate with each other directly or indirectly via a communication infrastructure are assumed. In a viewpoint of the first vehicle 2a illustrated in FIG. 7, the ego-vehicle 2a corresponds to a host moving object, and the second vehicle 2b, which is also another road user 3 present in a traveling environment of the ego-vehicle 2a, corresponds to a target moving object. On the other hand, in a viewpoint of the second vehicle 2b illustrated in FIG. 8, the ego-vehicle 2b corresponds to the host moving object, and the first vehicle 2a, which is also the other road user 3 present in a traveling environment of the ego-vehicle 2b, corresponds to the target moving object.

The vehicle 2 illustrated in FIGS. 7 and 8 is a road user such as an automobile or a truck in which autonomous driving is executed. The autonomous driving is classified into levels according to the degree of manual intervention by an occupant in a dynamic driving task (hereinafter, referred to as DDT). The autonomous driving may be implemented by autonomous traveling control in which a system executes all DDTs when operated, such as conditional driving automation, advanced driving automation, or full driving automation. The autonomous driving may be implemented in advanced driver-assistance control in which a driver as an occupant executes some or all DDTs, such as driver-assistance or partial driving automation. The autonomous driving may be implemented by either one, a combination, or switching of the autonomous traveling control and the advanced driver-assistance control.

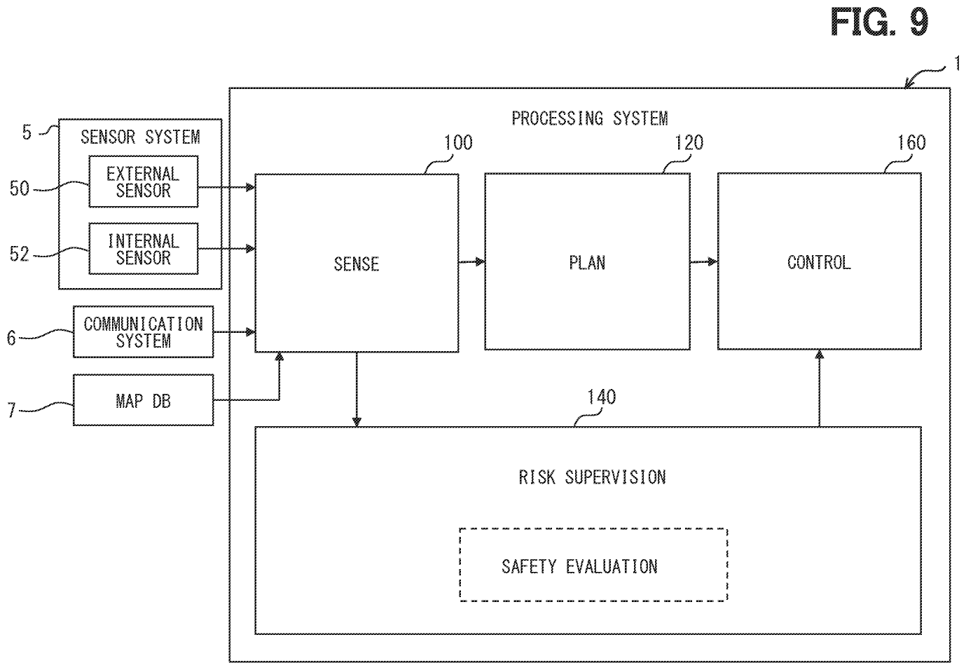

A sensor system 5, a communication system 6, a map data base (DB) 7, and an information presentation system 4 illustrated in FIGS. 6 and 9 are mounted on the host vehicle 2. The sensor system 5 acquires sensor data that can be used by the processing system 1 by detecting an outside and an inside of the vehicle 2. Therefore, the sensor system 5 includes an external sensor 50 and an internal sensor 52.

The external sensor 50 may detect a target present in the outside of the vehicle 2. The target detection type external sensor 50 is at least one of, for example, a camera, a light detection and ranging/laser imaging detection and ranging (LIDAR), a laser radar, a millimeter wave radar, and an ultrasonic sonar. The external sensor 50 may detect a state of atmosphere in the outside of the vehicle 2. The atmosphere detection type external sensor 50 is at least one of, for example, an outside air temperature sensor and a humidity sensor.

The internal sensor 52 may detect a specific physical quantity related to vehicle motion (hereinafter referred to as kinematic properties) in the inside of the vehicle 2. The physical quantity detection type internal sensor 52 is at least one of, for example, a speed sensor, an acceleration sensor, and a gyro sensor. The internal sensor 52 may detect a state of an occupant in the inside of the host vehicle 2. The occupant detection type internal sensor 52 is, for example, at least one of an actuator sensor, a driver status monitor, a biological sensor, a seating sensor, and an in-vehicle device sensor. In particular, as the actuator sensor, at least one of, for example, an accelerator sensor, a brake sensor, and a steering sensor that detect an operating state of an occupant related to a motion actuator of the host vehicle 2 is used.

The communication system 6 acquires communication data that can be used by the processing system 1 by wireless communication. The communication system 6 may receive a positioning signal from an artificial satellite of a global navigation satellite system (GNSS) present in the outside of the vehicle 2. The positioning type communication system 6 is, for example, a GNSS receiver. The communication system 6 may transmit and receive a communication signal to and from a V2X system present in the outside of the host vehicle 2. The V2X type communication system 6 is at least one of, for example, a dedicated short range communications (DSRC) communication device and a cellular V2X (C-V2X) communication device. Communication between the vehicles 2 (2a, 2b) assumed in the first embodiment can be implemented via the V2X type communication system 6 in each of the vehicles 2. The communication system 6 may transmit and receive a communication signal to and from a terminal present in the inside of the host vehicle 2. The terminal communication type communication system 6 is at least one of, for example, a Bluetooth (registered trademark) device, a Wi-Fi (registered trademark) device, and an infrared communication device.

The map DB 7 stores map data that can be used by the processing system 1. The map DB 7 includes at least one non-transitory tangible storage medium among, for example, a semiconductor memory, a magnetic medium, and an optical medium. The map DB 7 may be a DB of a locator that estimates a self-state amount of the vehicle 2 including a self-position. The map DB may be a DB of a navigation unit that navigates a travel path of the vehicle 2. The map DB 7 may be constructed by a combination of multiple DBs.

The map DB 7 acquires and stores latest map data by, for example, communicating with an external center via the V2X type communication system 6. The map data is two-dimensionally or three-dimensionally digitalized as data representing a traveling environment of the vehicle 2. As the three-dimensional map data, digital data of a high definition map may be used. The map data may include road data representing at least one of, for example, a position coordinate, a shape, and a road surface condition of a road structure. The map data may include marking data representing at least one of, for example, a traffic sign, a road display, and a position coordinate and a shape of a lane marking attached to a road. The marking data included in the map data may represent landmarks such as a traffic-control sign, an arrow marking, a lane marking, a stop line, a direction sign, a landmark beacon, a rectangular sign, a business sign, or a line pattern change of a road. The map data may include structure data representing at least one of, for example, position coordinates and shapes of a building and a traffic light facing a road. The marking data included in the map data may represent landmarks such as a street light, an edge of a road, a reflecting plate, a pole, or a back side of a traffic sign.

The information presentation system 4 presents notification information to occupants including the driver of the vehicle 2. The information presentation system 4 includes a visual presentation unit, an auditory presentation unit, and a skin sense presentation unit. The visual presentation unit presents the notification information by stimulating a visual sense of the occupant. The visual presentation unit is at least one of, for example, a head-up display (HUD), a multi function display (MFD), a combination meter, a navigation unit, and a light emitting unit. The auditory presentation unit presents the notification information by stimulating an auditory sense of the occupant. The auditory presentation unit is at least one of, for example, a speaker, a buzzer, and a vibration unit. The skin sense presentation unit presents the notification information by stimulating a skin sense of the occupant. The skin sense stimulated by the skin sense presentation unit includes at least one of, for example, a tactile sense, a temperature sense, and a wind sense. The skin sense presentation unit is at least one of, for example, a vibration unit of a steering wheel, a vibration unit of a driver's seat, a reaction force unit of the steering wheel, a reaction force unit of an accelerator pedal, a reaction force unit of a brake pedal, and an air conditioning unit.

As illustrated in FIG. 6, the processing system 1 is connected to the sensor system 5, the communication system 6, the map DB 7, and the information presentation system 4 via at least one of, for example, a local area network (LAN), a wire harness, an internal bus, and a wireless communication line. The processing system 1 includes at least one dedicated computer. The dedicated computer constituting the processing system 1 may be an integrated electronic control unit (ECU) that integrates driving control of the vehicle 2. The dedicated computer constituting the processing system 1 may be a determination ECU that determines the DDT in the driving control of the vehicle 2. The dedicated computer constituting the processing system 1 may be a monitoring ECU that monitors the driving control of the vehicle 2. The dedicated computer constituting the processing system 1 may be an evaluation ECU that evaluates the driving control of the vehicle 2.

The dedicated computer constituting the processing system 1 may be a navigation ECU that navigates the travel path of the vehicle 2. The dedicated computer constituting the processing system 1 may be a locator ECU that estimates the self-state amount including the self-position of the vehicle 2. The dedicated computer constituting the processing system 1 may be an actuator ECU that controls the motion actuator of the vehicle 2. The dedicated computer constituting the processing system 1 may be a human machine interface (HMI) control unit (HCU) that controls the information presentation in the vehicle 2. The dedicated computer constituting the processing system 1 may be at least one external computer that constructs an external center or a mobile terminal capable of communicating via, for example, the communication system 6.

The dedicated computer constituting the processing system 1 includes at least one memory 10 and at least one processor 12. The memory 10 is at least one non-transitory tangible storage medium among, for example, a semiconductor memory, a magnetic medium, and an optical medium that temporarily store a program, data, and the like that can be read by a computer. The processor 12 includes, as a core, at least one of, for example, a central processing unit (CPU), a graphics processing unit (GPU), and a reduced instruction set computer (RISC)-CPU.

The processor 12 executes multiple instructions included in a processing program stored in the memory 10 as software. Accordingly, the processing system 1 constructs multiple functional blocks for performing the driving-related processing of the vehicle 2. In this way, in the processing system 1, in order to perform the driving-related processing of the vehicle 2, the multiple functional blocks are constructed by the processing program stored in the memory 10 causing the processor 12 to execute the multiple instructions. As illustrated in FIG. 8, the multiple functional blocks constructed by the processing system 1 include a detection block 100, a planning block 120, a risk monitoring block 140, and a control block 160.

The detection block 100 acquires the sensor data from the external sensor 50 and the internal sensor 52 of the sensor system 5. The detection block 100 acquires the communication data from the communication system 6. The detection block 100 acquires the map data from the map DB 7. The detection block 100 detects internal and external environments of the vehicle 2 by fusion using these acquired data as inputs. By detecting the internal and external environments, the detection block 100 generates detection information to be given to the subsequent planning block 120 and risk monitoring block 140. In this way, it can be said that when the detection information is generated, the detection block 100 acquires the data from the sensor system 5 and the communication system 6, recognizes or interprets meaning of the acquired data, and integrates the acquired data to grasp situations including an external situation of the vehicle 2, a situation in which the vehicle 2 is placed, and an internal situation of the vehicle 2. The detection block 100 may give substantially the same detection information to the planning block 120 and the risk monitoring block 140. The detection block 100 may give different detection information to the planning block 120 and the risk monitoring block 140.

The detection information generated by the detection block 100 describes a state detected for each scene in the traveling environment of the host vehicle 2. The detection block 100 may generate detection information on an object in the outside of the vehicle 2 by detecting the object. The object may be another road user 3, an obstacle, and a structure. The detection information on the object may represent at least one of, for example, a distance to the object, a relative speed of the object, a relative acceleration of the object, and an estimated state by tracking detection of the object. The detection information on the object may further represent a type recognized or specified based on a state of the detected object. The detection block 100 may generate detection information on a traveling road on which the vehicle 2 travels at present and in future by detecting the traveling road. The detection information on the traveling road may represent at least one state among, for example, a road surface, a lane, a road end, and a free space.

The detection block 100 may generate detection information on the self-state amount including the self-position of the vehicle 2 by localization of presumptively detecting the self-state amount. The detection block 100 may generate update information on map data related to the traveling road of the vehicle 2 at the same time as the detection information on the self-state amount, and feedback the update information to the map DB 7. The detection block 100 may generate detection information on a marking associated with the traveling road of the host vehicle 2 by detecting the marking. The detection information on the marking may represent at least one state of, for example, a sign, a lane marking, and a traffic light. The detection information on the marking may further represent a traffic rule recognized or specified based on a state of the marking. The detection block 100 may generate detection information on a weather situation for each scene in which the host vehicle 2 travels by detecting the weather situation. The detection block 100 may generate detection information on a time for each traveling scene of the vehicle 2 by detecting the time. The planning block 120 acquires the detection information from the detection block 100. The planning block 120 plans the driving control of the vehicle 2 according to the acquired detection information. In the planning of the driving control, a control command related to a navigation operation of the vehicle 2 and an assistance operation of the driver is generated. That is, the planning block 120 implements a DDT function that generates the control command as a motion control request for the vehicle 2. The control command generated by the planning block 120 may include a control parameter for controlling the motion actuator of the vehicle 2. Examples of the motion actuator to which the control command is output include at least one of, for example, an internal combustion engine, an electric motor, a power train in which the internal combustion engine and the electric motor are combined, a brake device, and a steering device.

The planning block 120 may generate a control command so as to comply with a driving policy by using the driving policy and a safety model described following safety of the driving policy. The driving policy followed by the safety model is defined based on, for example, a vehicle level safety strategy that guarantees safety of the intended functionality (hereinafter referred to as SOTIF). In other words, the safety model is described by following the driving policy on which the vehicle level safety strategy is implemented and modeling the SOTIF. The planning block 120 may train the safety model by a machine learning algorithm that back-propagates a driving control result to the safety model. As the safety model to be trained, at least one learning model among, for example, deep learning by a neural network such as a deep neural network (DNN) and reinforcement learning may be used. The safety model may be a safety-related model itself, or may be a model constituting a part of the safety-related model.

The planning block 120 may plan a path to be traveled in the future by the vehicle 2 by the driving control prior to generating the control command. The path planning may be executed by, for example, computation such as simulation in order to navigate the vehicle 2 based on the detection information. That is, the planning block 120 may implement a DDT function of planning the path as a tactical action of the vehicle 2. The planning block 120 may further plan, for the vehicle 2 following the planned path, an appropriate trajectory based on the acquired detection information prior to generating the control command. That is, the planning block 120 may implement a DDT function of planning the trajectory of the vehicle 2. The trajectory planned by the planning block 120 may define at least one of, for example, a traveling position, a speed, an acceleration, and a yaw rate in time series, as the kinematic properties related to the host vehicle 2. The time series trajectory planning constructs a scenario of the future traveling by the navigation on the host vehicle 2. The planning block 120 may generate the trajectory by planning using the safety model. In this case, the safety model may be trained by a machine learning algorithm based on a calculation result obtained by calculating a cost function for giving a cost to the generated trajectory.

The planning block 120 may plan adjustment of a level of driving automation in the vehicle 2 according to the acquired detection information. The adjustment of the level of driving automation may include takeover between the autonomous driving and manual driving. The takeover between the autonomous driving and the manual driving may be achieved in a scenario in association with entry or exit of an operational design domain in which the autonomous driving is executed by setting the operational design domain. In a scenario of exit from the operational design domain, that is, a scenario of takeover from the autonomous driving to the manual driving, an unreasonable situation in which it is determined that an unreasonable risk is present based on, for example, the safety model is exemplified as a use case. In the use case, the planning block 120 may plan a DDT fallback for causing a driver who will be a fallback ready user to give the vehicle 2 a minimal risk maneuver and transition the vehicle 2 to a minimal risk condition.

The adjustment of the level of driving automation may include degradation traveling of the vehicle 2. In a scenario of degradation traveling, if an unreasonable risk is present due to takeover to manual driving, an unreasonable situation determined based on, for example, the safety model is exemplified as a use case. In the use case, the planning block 120 may plan a DDT fallback for transitioning the vehicle 2 to the minimal risk condition by autonomous traveling and autonomous stopping. The DDT fallback for transitioning the vehicle 2 to the minimal risk condition is not only achieved in adjustment of lowering the level of driving automation, but also achieved in adjustment of maintaining the level of driving automation and causing the host vehicle 2 to perform the degradation traveling, for example, in a minimum risk maneuver (MRM). In the DDT fallback for transitioning the vehicle 2 to the minimal risk condition, prominence of the transitioning situation may be enhanced by at least one of, for example, illumination, a horn sound, a signal, and a gesture.

The risk monitoring block 140 acquires the detection information from the detection block 100. The risk monitoring block 140 monitors a risk between the vehicle 2 and the other road user 3 for each scene based on the acquired detection information. The risk monitoring block 140 executes the risk monitoring of the other road user 3 in time series based on the detection information so as to guarantee the SOTIF of the vehicle 2. The other road user 3 assumed in the risk monitoring includes a non vulnerable road user such as an automobile, a truck, a motorcycle, and a bicycle, and a vulnerable road user such as a pedestrian. The other road user 3 assumed in the risk monitoring may further include an animal.

The risk monitoring block 140 sets, based on the acquired detection information for each scene, a safety envelope based on, for example, the vehicle level safety strategy, which guarantees the SOTIF in the vehicle 2. The risk monitoring block 140 may set a safety envelope between the vehicle 2 and the other road user 3 by using the safety model following the above driving policy. The safety model used for setting the safety envelope may be designed so as to avoid an unreasonable risk or potential accident responsibility caused by a misuse of the road user in accordance with an accident responsibility rule. In other words, the safety model may be designed such that the host vehicle 2 observes the accident responsibility rule following the driving policy. As such a safety model, for example, a responsibility sensitive safety model disclosed in Patent Literature 1 is exemplified.

In the setting of the safety envelope, based on the safety model assumed to follow the driving policy for the vehicle 2 and the other road user 3, a safety distance may be assumed based on a profile related to at least one kinematic properties. The safety distance defines a boundary where a physics based margin is secured around the host vehicle 2 with respect to predicted motion of the other road user 3. The safety distance may be assumed in consideration of a response time until an appropriate response is executed by each of the vehicle 2 and the other road user 3. The safety distance may be assumed to observe the accident responsibility rule. In a scene in which a lane structure such as a lane is present, a safety distance for avoiding risks of a rear-end crash and a head-on crash in a longitudinal direction of the vehicle 2 and a safety distance for avoiding a risk of a side crash in a lateral direction of the vehicle 2 may be calculated. On the other hand, in a scene in which the lane structure is not present, a safety distance for avoiding a risk of a trajectory crash in any direction of the vehicle 2 may be calculated.

The risk monitoring block 140 may specify a situation for each scene of relative motion between the vehicle 2 and the other road user 3 prior to setting of the above safety envelope. In the scene in which the lane structure such as the lane is present, a situation in which the risks of the rear-end crash and the head-on crash in the longitudinal direction are assumed and a situation in which the risk of the side crash in the lateral direction is assumed may be specified. In the situation specifying in the longitudinal direction and the lateral direction, state amounts related to the vehicle 2 and the other road user 3 may be converted into a coordinate system assuming straight lanes. On the other hand, in the scene in which the lane structure is not present, a situation in which the risk of the trajectory crash in any direction of the vehicle 2 is assumed may be specified. In the situation specifying function described above, at least a part of the state specifying function may be executed by the detection block 100, so that a situation specifying result may be given to the risk monitoring block 140 as the detection information.

The risk monitoring block 140 executes safety determination between the host vehicle 2 and the other road user 3 based on the set safety envelope and the acquired detection information for each scene. That is, the risk monitoring block 140 executes safety determination by testing whether there is an envelope violation that is a violation of the safety envelope in a traveling scene interpreted based on the detection information between the vehicle 2 and the other road user 3. When the safety distance is assumed in the setting of the safety envelope, if an actual distance between the vehicle 2 and the other road user 3 exceeds the safety distance, it may be determined that there is no envelope violation. On the other hand, if the actual distance between the vehicle 2 and the other road user 3 is equal to or less than the safety distance, it may be determined that there is an envelope violation.

When it is determined that there is an envelope violation, the risk monitoring block 140 may calculate a reasonable scenario for giving an appropriate action to be taken as the appropriate response to the vehicle 2 by simulation. In the simulation of the reasonable scenario, state transition between the vehicle 2 and the other road user 3 is estimated, so that an action to be taken for each transition state may be set as a constraint on the vehicle 2. In the setting of the action, a limit value assumed for at least one kinematic properties given to the vehicle 2 may be calculated so as to limit the kinematic properties as a constraint on the vehicle 2.

The risk monitoring block 140 may directly calculate a limit value for observing the accident responsibility rule based on the profile related to at least one kinematic properties, based on the safety model assumed to follow the driving policy for the vehicle 2 and the other road user 3. It can be said that the direct calculation of the limit value itself is the setting of the safety envelope and is also setting of a constraint on the driving control. Therefore, when an actual value that is safer than the limit value is detected, it may be determined that there is no envelope violation. On the other hand, when an actual value beyond the limit value is detected, it may be determined that there is an envelope violation.

For example, the risk monitoring block 140 may store, in the memory 10, at least one type of evidence information among, for example, the detection information used for setting the safety envelope, determination information indicating a determination result of the safety envelope, detection information having influence on the determination result, and a simulated scenario. The memory 10 in which the evidence information is stored may be mounted in the vehicle 2 according to the type of the dedicated computer constituting the processing system 1, or may be installed in an external center or the like outside the vehicle 2. The evidence information may be stored in an unencrypted state, or may be stored in an encrypted or hashed manner. The storage of the evidence information is executed at least when it is determined that there is an envelope violation. Of course, the storage of the evidence information may also be executed when it is determined that there is no envelope violation. The evidence information when it is determined that there is no envelope violation can be used as a lagging measure at a storage time point, and can also be used as a leading measure in the future.

The control block 160 acquires the control command from the planning block 120. The control block 160 acquires the determination information related to the safety envelope from the risk monitoring block 140. The control block 160 implements a DDT function of controlling the motion of the vehicle 2. When the control block 160 acquires the determination information indicating that there is no envelope violation, the control block 160 executes the planned driving control of the vehicle 2 according to the control command.

On the other hand, when the control block 160 acquires the determination information indicating that there is an envelope violation, the control block 160 gives a constraint following the driving policy based on the determination information on the planned driving control of the host vehicle 2. The constraint on the driving control may be a functional constraint. The constraint on the driving control may be a degraded constraint. The constraint on the driving control may be a constraint different from the above constraints. The constraint on the driving control is given by limitation of the control command. When the reasonable scenario is simulated by the risk monitoring block 140, the control block 160 may limit the control command according to the scenario. At this time, when the limit value is set for the kinematic properties of the vehicle 2, the control parameter for the motion actuator included in the control command may be corrected based on the limit value.

Hereinafter, details of the first embodiment will be described.

As illustrated in FIGS. 7, 8, and 10 to 15, the first embodiment assumes a lane structure Ls with separated lanes. The lane structure Ls restricts the motion of the vehicle 2 and the other road user 3 with a direction in which the lane extends as the longitudinal direction. The lane structure Ls restricts the motion of the vehicle 2 and the other road user 3 with a width direction or an alignment direction of the lanes as the lateral direction.

A driving policy in the lane structure Ls is defined, for example, in the following (A) to (E) or the like between the first vehicle 2a and the second vehicle 2b, one of which is assumed to be the vehicle 2 and the other is the other road user 3. A front of the vehicle 2 means, for example, a traveling direction of a turning circle at a current steering angle of the vehicle 2, a traveling direction of a straight line passing through a center of gravity of the vehicle orthogonal to an axle of the vehicle 2, or a traveling direction of the sensor system 5 of the vehicle 2 on an axis line of focus of expansion (FOE) of the same camera from a front camera module.
(A) Do not hit a vehicle traveling in front from behind (Do not hit someone from behind).
(B) Do not cut in recklessly between other vehicles (Do not cut-in recklessly).
(C) Yield to another vehicle even when own vehicle has a priority (Right-of-way is given, not taken).
(D) Be cautious in areas with limited visibility.
(E) If the host vehicle can avoid a crash without causing another one, take a reasonable action for that purpose (If you can avoid an accident without causing another one, you must do it).

The safety model obtained by modeling the SOTIF, which is a model following the driving policy, assumes that an action of a road user that does not lead to an unreasonable situation is an appropriate reasonable action to be taken. An unreasonable situation between the vehicle 2 and the other road user 3 in the lane structure Ls is a head-on crash, a rear-end crash, or a side crash. A reasonable action for the head-on crash includes, for example, a braking by the reversely running vehicle 2a or 2b among the vehicles 2, between the first vehicle 2a and the second vehicle 2b, one of which is the other road user 3. A reasonable action for the rear-end crash includes, for example, avoidance a sudden braking of a certain degree or more by the vehicle 2a or 2b traveling in front among the first vehicle 2a and the second vehicle 2b and avoidance of a rear-end crash by the vehicle 2b or 2a traveling behind on the premise of the above. A reasonable action for the side crash includes, for example, a steering of the vehicles 2a and 2b traveling side by side in a direction separating from each other among the first vehicle 2a and the second vehicle 2b. When assuming the reasonable actions, the state amounts related to the vehicle 2 and the other road user 3 are converted into an orthogonal coordinate system that defines the longitudinal direction and the lateral direction assuming a linear and planar lane structure Ls regardless of whether the lane structure Ls has curved lanes or high and low lanes.

It is preferable that the safety model is designed in accordance with an accident responsibility rule in which a moving object that does not take a reasonable action is responsible for an accident. In the safety model used to monitor a risk between the vehicle 2 and the other road user 3 under the accident responsibility rule in the lane structure Ls, the safety envelope for the vehicle 2 is set so as to avoid potential accident responsibility by a reasonable action. Therefore, the risk monitoring block 140 in a normal situation of the entire processing system 1 in the vehicle 2 determines presence or absence of the envelope violation by checking the safety distance based on the safety model for each traveling scene with respect to the actual distance between the vehicle 2 and the other road user 3. When there is an envelope violation, the risk monitoring block 140 simulates a scenario for giving a reasonable action to the vehicle 2. By the simulation, the risk monitoring block 140 sets a limit value related to at least one of, for example, a speed and an acceleration as the constraint on the driving control by the control block 160.

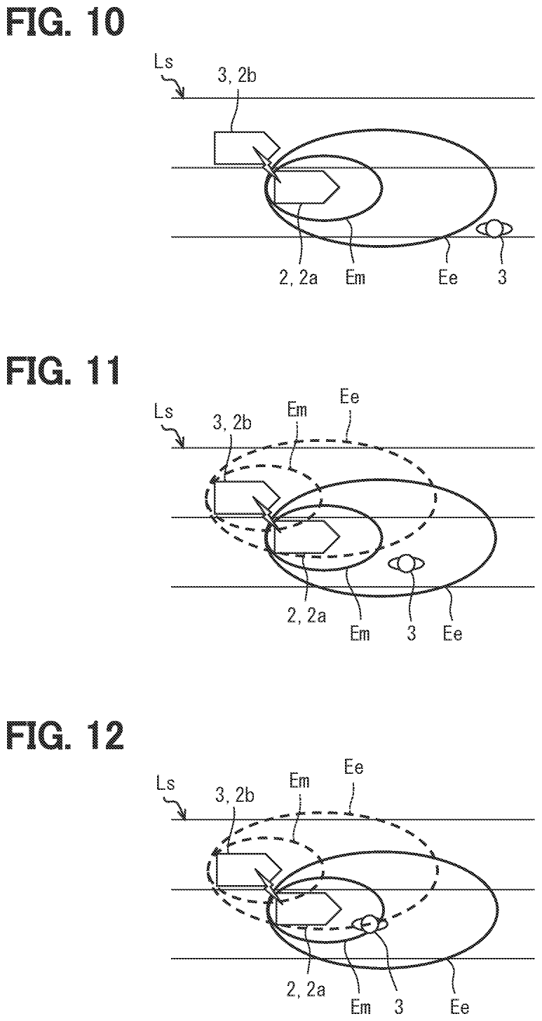

As illustrated in FIGS. 10 to 15, the risk monitoring block 140 assumes a model envelope Em as a safety envelope based on the above-described safety model among the safety envelopes in which the SOTIF is set following the driving policy. Further, the risk monitoring block 140 assumes an extended envelope Ee as a safety envelope obtained by adding a physics based margin to the model envelope Em. Under these assumption, a safety distance that defines the extended envelope Ee is set to be larger than a safety distance that defines the model envelope Em. That is, the extended envelope Ee is set in a wide range including the model envelope Em. Therefore, the margin may be set such that a fixed distance, or a variable distance based on for example, a safety model is added to the safety distance of the model envelope Em.

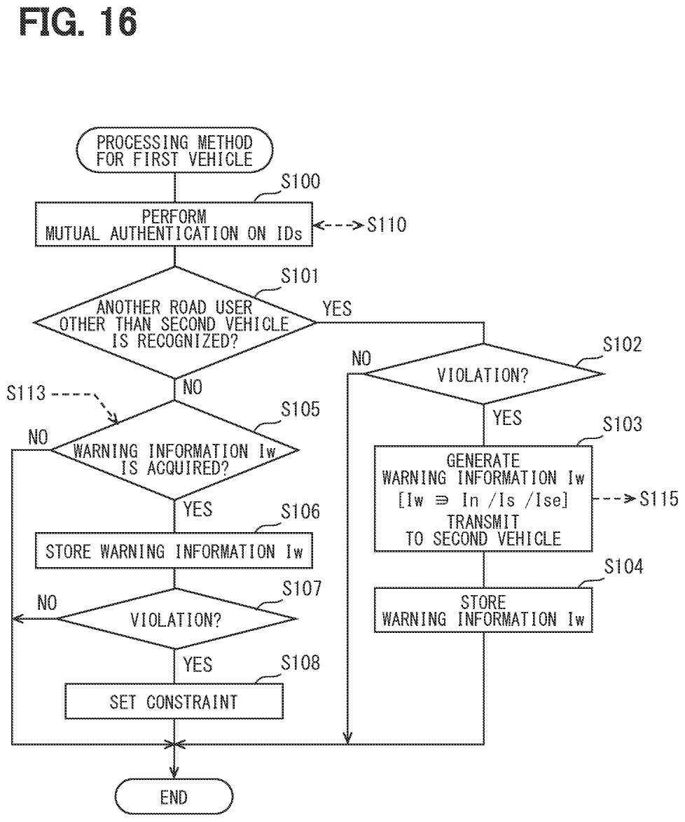

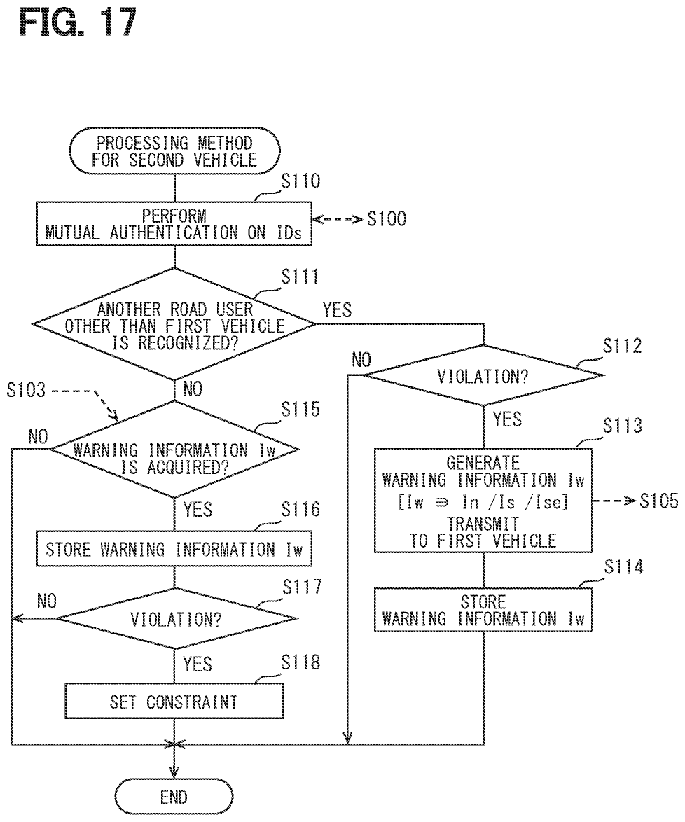

In the first embodiment, in the first vehicle 2a and the second vehicle 2b assumed as the paired vehicles 2 that directly or indirectly communicate with each other, a processing method of performing the driving-related processing in cooperation with the respective functional blocks constructed by the processing system 1 is executed according to flowcharts illustrated in FIGS. 16 and 17. The processing method according to the first embodiment is repeatedly executed in each of the vehicles 2a and 2b while a mutual distance between the first vehicle 2a and the second vehicle 2b is within a set range. Each “S” in the processing method in the following description means each of multiple steps executed by the multiple instructions included in the processing program in the processing system 1 of each of the vehicles 2a and 2b.

In S100 and S110 illustrated in FIGS. 16 and 17, each risk monitoring block 140 of the first vehicle 2a and the second vehicle 2b performs mutual authentication by exchanging a user ID including an authentication key through mutual communication. The mutual authentication may be mere confirmation of security and confirmation of whether communication is possible. The mutual authentication may be accompanied by confirmation of whether the used safety model or driving policy has a safety envelope setting function in addition to the confirmation of security and the confirmation of whether communication is possible.

As illustrated in FIG. 16, in S101 following S100 of the processing method, the risk monitoring block 140 of the first vehicle 2a determines whether the other road user 3 other than the second vehicle 2b whose mutual distance with the first vehicle 2a is within a monitoring range of the safety envelope is recognized. Whether or not the other road user 3 other than the second vehicle 2b is recognized is determined based on the detection information by the detection block 100 of the first vehicle 2a. The monitoring range of the safety envelope in the first vehicle 2a is set to a wide range including the model envelope Em and the extended envelope Ee illustrated in FIGS. 10 to 12. Therefore, when the risk monitoring block 140 of the first vehicle 2a determines in S101 that the other road user 3 other than the second vehicle 2b is recognized in the monitoring range of the first vehicle 2a, the current flow for the first vehicle 2a is transitioned to S102 as illustrated in FIG. 16.

In S102, the risk monitoring block 140 of the first vehicle 2a monitors the envelope violation related to the safety envelope with respect to the other road user 3 other than the second vehicle 2b in the first vehicle 2a based on the safety model of the first vehicle 2a. As illustrated in FIG. 10, in the first vehicle 2a, when the other road user 3 other than the second vehicle 2b is entirely present outside the range of the extended envelope Ee and outside a range of the model envelope Em, the envelope violation is not recognized. Therefore, when the risk monitoring block 140 of the first vehicle 2a determines in S102 that there is no envelope violation, the current flow for the first vehicle 2a is ended as illustrated in FIG. 16.

On the other hand, in the first vehicle 2a, when at least a part of the other road user 3 other than the second vehicle 2b is present inside the range of the extended envelope Ee and outside the range of the model envelope Em as illustrated in FIG. 11, an extended envelope violation as the envelope violation is recognized. Further, in the first vehicle 2a, when at least a part of the other road user 3 other than the second vehicle 2b is present inside the range of the model envelope Em and inside the range of the extended envelope Ee as illustrated in FIG. 12, a model envelope violation as the envelope violation is recognized.

Therefore, when the risk monitoring block 140 of the first vehicle 2a determines in S102 that there is any one of the model envelope violation and an extended model violation, the current flow for the first vehicle 2a is sequentially transitioned to S103 and S104, as illustrated in FIG. 16. That is, S103 and S104 are executed when the envelope violation with respect to the other road user 3 other than the second vehicle 2b, which is detected in the first vehicle 2a, is recognized.

In S103, the risk monitoring block 140 of the first vehicle 2a generates warning information Iw for warning the second vehicle 2b of the envelope violation with respect to the other road user 3. The warning information Iw may include notification information In for pushing notification from the first vehicle 2a to the second vehicle 2b about occurrence of an event such as the envelope violation. The warning information lw may be combined information in which situation information Is is added to the notification information In. The situation information Is may include envelope information Ise related to the safety envelope set in the first vehicle 2a.

The envelope information Ise may represent a range of a safety envelope including the safety distance, which serves as a criterion for determining the envelope violation in the first vehicle 2a. The envelope information Ise may represent at least one risk type among, for example, a rear-end crash risk, a head-on crash risk, a side crash risk, an intersection risk, a blind spot risk, and detailed situations thereof, which are assumed as relative states between the first vehicle 2a and the other road user 3, by a safety model that defines the safety envelope that serves as the criterion for determining the envelope violation.

The envelope information Ise may represent, as the detection information of the first vehicle 2a detected by the detection block 100 of the first vehicle 2a in the scene of the envelope violation, at least one of, for example, a self-state amount including a position (that is, a localization estimation value), a distance, a speed, an acceleration or deceleration, a relative speed, a relative acceleration, an estimated state including vectors of the above, and a type. In particular, the envelope information Ise may represent, as a kinematic properties of the envelope violation, which is beyond the limit value obtained by the constraint setting of the risk monitoring block 140 in the first vehicle 2a, at least one type of detection information detected by the detection block 100 of the first vehicle 2a among the speed, the acceleration or deceleration, and the like of the first vehicle 2a.

The envelope information Ise may represent, as the detection information of the other road user 3 detected by the detection block 100 of the first vehicle 2a in the scene of the envelope violation, at least one of, for example, a position, a distance, a speed, an acceleration or deceleration, a relative speed, a relative acceleration, an estimated state including vectors of the above, and a type. In particular, the envelope information Ise may represent, as the kinematic properties of the envelope violation, which is beyond the limit value obtained by the constraint setting of the risk monitoring block 140 in the first vehicle 2a, at least one type of detection information detected by the detection block 100 of the first vehicle 2a among a speed, an acceleration or deceleration, and the like of the other road user 3. The envelope information Ise may include an image or a video including the other road user 3, which is captured by a camera that is the external sensor 50 of the first vehicle 2a in the scene of the envelope violation.

In addition to the envelope information Ise, the situation information Is may represent, as a planning situation in the planning block 120 of the first vehicle 2a in the scene of the envelope violation, at least one of, for example, a path, a trajectory, a control parameter, an level of driving automation (including a case where the manual driving is set to a level 0). The situation information Is may represent, as a road situation in the scene of the envelope violation, at least one of, for example, a traffic rule, a marking, a road structure, a location, a section, a road surface condition, a light and shade condition, a construction condition, a traffic congestion situation, an existence situation of an obstacle including a falling object, a feature structure around a road, and a blind spot caused by the feature structure or a moving object type. The situation information Is may represent at least one of, for example, a time period of a violation scene including distinction between day and night and a climate condition (that is, weather) of the violation scene, in the scene of the envelope violation.

The warning information Iw generated in S103 can be transmitted from the first vehicle 2a to the second vehicle 2b according to the control of the communication system 6 by the risk monitoring block 140 of the first vehicle 2a. In other words, the risk monitoring block 140 of the first vehicle 2a generates the warning information Iw of the envelope violation such that the warning information Iw is transmitted in real time from the first vehicle 2a to the second vehicle 2b in response to the determination that there is an envelope violation. In the present embodiment, the transmission between the vehicles 2a and 2b may be achieved directly by the communication systems 6 such as the V2V type communication systems 6, may be achieved indirectly via a remote center such as a cloud server, or may be achieved via a mesh network configured between multiple vehicles including the vehicles 2a and 2b.

In S104, the risk monitoring block 140 of the first vehicle 2a stores the generated warning information Iw in the memory 10 of the first vehicle 2a. The warning information Iw may be stored in association with a time stamp indicating a generation time or a transmission time of the first vehicle 2a, so that the warning information Iw at multiple time points may be accumulated. The warning information Iw may be stored through encryption processing or hashing processing in the first vehicle 2a. The warning information Iw may be stored as evidence information. The warning information Iw may be deleted after a set period elapses since the generation time or the transmission time of the first vehicle 2a. When the execution of S104 is ended, the current flow for the first vehicle 2a is ended.

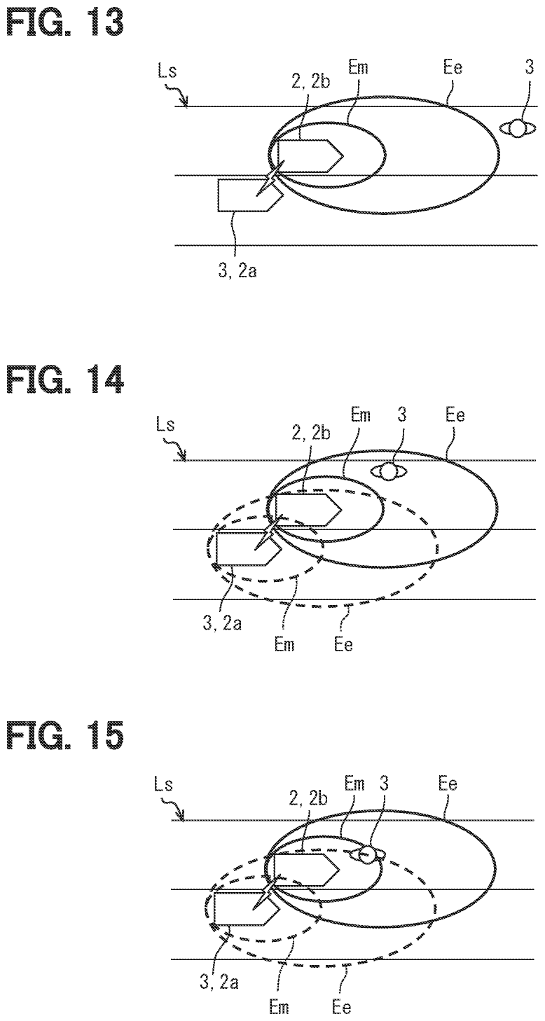

As illustrated in FIG. 17, in S111 following the above S110, the risk monitoring block 140 of the second vehicle 2b determines whether the other road user 3 other than the first vehicle 2a whose mutual distance with the second vehicle 2b is within the monitoring range of the safety envelope is recognized. Whether or not the other road user 3 other than the first vehicle 2a is recognized is determined based on the detection information by the detection block 100 of the second vehicle 2b. The monitoring range of the safety envelope in the second vehicle 2b is set to a wide range including the model envelope Em and the extended envelope Ee illustrated in FIGS. 13 to 15. The monitoring range of the safety envelope, the range of the model envelope Em, and the range of the extended envelope Ee in the second vehicle 2b are set to the same or different ranges as those in the first vehicle 2a, respectively. Therefore, when the risk monitoring block 140 of the second vehicle 2b determines in S111 that the other road user 3 other than the first vehicle 2a is not recognized in the monitoring range of the second vehicle 2b, the current flow for the second vehicle 2b is transitioned to S115 as illustrated in FIG. 17.

In S115, the risk monitoring block 140 of the second vehicle 2b determines whether the warning information Iw from the first vehicle 2a is acquired by receiving through the communication system 6 of the second vehicle 2b. In S115, when the risk monitoring block 140 of the second vehicle 2b determines that the warning information lw is not acquired, the current flow for the second vehicle 2b is ended.

On the other hand, in S115, when the risk monitoring block 140 of the second vehicle 2b determines that the warning information Iw is acquired, the current flow for the second vehicle 2b is sequentially transitioned to S116 and S117. That is, S116 and S117 are executed in response to the acquisition of the warning information lw in real time when the other road user 3, which is a violation target, is not detected in the second vehicle 2b, even though the envelope violation with respect to the other road user 3 other than the second vehicle 2b is recognized in the first vehicle 2a, as illustrated in FIGS. 11 and 12.

As illustrated in FIG. 17, in S116, the risk monitoring block 140 of the second vehicle 2b stores the acquired warning information Iw in the memory 10 of the second vehicle 2b. The warning information Iw may be stored in association with the time stamp indicating the generation time or the transmission time of the first vehicle 2a or an acquisition time (that is, a receiving time) of the second vehicle 2b, so that the warning information Iw at multiple time points may be accumulated. The warning information Iw may be stored through encryption processing or hashing processing in the second vehicle 2b. The warning information Iw may be stored as evidence information. The warning information Iw may be deleted after a setting period elapses since the generation time or the transmission time of the first vehicle 2a or the acquisition time of the second vehicle 2b.

In S117, the risk monitoring block 140 of the second vehicle 2b determines presence or absence of an envelope violation for a safety envelope between the second vehicle 2b and the other road user 3, which is notified by the warning information Iw as the violation target in the first vehicle 2a and is not detected in the second vehicle 2b. In the second vehicle 2b, when the other road user 3 which is not detected is entirely outside the range of the extended envelope Ee and outside the range of the model envelope Em as illustrated in FIG. 11, the envelope violation is not recognized. Therefore, when the risk monitoring block 140 of the second vehicle 2b determines in S117 that there is no envelope violation, the current flow for the second vehicle 2b is ended.

On the other hand, in the second vehicle 2b, when the other road user 3 which is not detected is at least partially inside the range of the extended envelope Ee and outside the range of the model envelope Em as illustrated in FIG. 12, the extended envelope violation as the envelope violation is recognized. Although not illustrated, in the second vehicle 2b, when the other road user 3 which is not detected is at least partially inside the range of the model envelope Em and inside the range of the extended envelope Ee, the model envelope violation as the envelope violation is recognized. For the recognition, information on the other road user 3, which is the violation target in the first vehicle 2a, may be added to the warning information Iw as the situation information Is or particularly as the envelope information Ise. The information on the other road user 3, which is the violation target in the first vehicle 2a, may be acquired from, for example, a remote center through the communication system 6 of the second vehicle 2b.

Therefore, when the risk monitoring block 140 of the second vehicle 2b determines in S117 that there is any one of the model envelope violation and the extended model violation, the current flow for the second vehicle 2b is transitioned to S118.

In S118, the risk monitoring block 140 of the second vehicle 2b sets a constraint for avoiding an unreasonable risk for motion control of the second vehicle 2b. The constraint for avoiding a risk may be a limit command for the control block 160 of the second vehicle 2b that gives a constraint for transitioning the second vehicle 2b to the minimal risk condition. However, when the envelope violation recognized in S117 is at least the extended envelope violation, such a constraint is not set in S118, and for example, information on the other road user 3 in the extended envelope violation may be commonly recognized for the first vehicle 2a as the detection information by the detection block 100 of the second vehicle 2b. When the execution in S118 is ended, the current flow for the second vehicle 2b is ended.

A case where the first vehicle 2a is a transmission side of the warning information Iw and the second vehicle 2b is a receiving side of the warning information lw has been described. Next, a case where the second vehicle 2b is the transmission side of the warning information Iw and the first vehicle 2a is the receiving side of the warning information Iw will be described.

As illustrated in FIG. 17, when the risk monitoring block 140 of the second vehicle 2b determines in S111 that the other road user 3 other than the first vehicle 2a is recognized in the monitoring range of the second vehicle 2b, the current flow for the second vehicle 2b is transitioned to S112.

In S112, the risk monitoring block 140 of the second vehicle 2b monitors the envelope violation related to the safety envelope with respect to the other road user 3 other than the first vehicle 2a in the second vehicle 2b based on the safety model of the second vehicle 2b. As illustrated in FIG. 13, in the second vehicle 2b, when the other road user 3 other than the second vehicle 2b is entirely present outside the range of the extended envelope Ee and outside the range of the model envelope Em, the envelope violation is not recognized. Therefore, when the risk monitoring block 140 of the second vehicle 2b determines in S112 that there is no envelope violation, the current flow for the second vehicle 2b is ended as illustrated in FIG. 17.

Before the end of the current flow, which is after it is determined that there is no envelope violation in S112, the risk monitoring block 140 of the second vehicle 2b may perform the common recognition with the first vehicle 2a by executing acquisition determination processing of the warning information Iw according to S115. Similarly, before the end of the current flow, which is after it is determined that there is no envelope violation in S102 described above, the risk monitoring block 140 of the first vehicle 2a may perform common recognition with the second vehicle 2b by executing the acquisition determination processing of the warning information Iw according to S115.

On the other hand, in the second vehicle 2b, when at least a part of the other road user 3 other than the first vehicle 2a is present outside the range of the model envelope Em and inside the range of the extended envelope Ee as illustrated in FIG. 14, the extended envelope violation as the envelope violation is recognized. Further, in the second vehicle 2b, when at least a part of the other road user 3 other than the first vehicle 2a is present inside the range of the model envelope Em and inside the range of the extended envelope Ee as illustrated in FIG. 15, the model envelope violation as the envelope violation is recognized.

Therefore, when the risk monitoring block 140 of the second vehicle 2b determines in S112 that there is any one of the model envelope violation and the extended model violation, the current flow for the second vehicle 2b is sequentially transitioned to S113 and S114, as illustrated in FIG. 17. That is, S113 and S114 are executed when the envelope violation with respect to the other road user 3 other than the first vehicle 2a, which is detected in the second vehicle 2b, is recognized.

In S113, the risk monitoring block 140 of the second vehicle 2b executes processing of reversely replacing the first vehicle 2a and the second vehicle 2b in the description of S103 as the processing of generating the warning information Iw. In S114, the risk monitoring block 140 of the second vehicle 2b executes processing of reversely replacing the first vehicle 2a and the second vehicle 2b in the description of S104 as processing of storing the warning information Iw. When the execution in S114 is ended, the current flow for the second vehicle 2b is ended.

Before the execution in S114 or before the end of the current flow after the execution in S114, the risk monitoring block 140 of the second vehicle 2b may perform the common recognition with the first vehicle 2a by executing the acquisition determination processing of the warning information Iw according to S115. Similarly, before the execution in S104 described above or before the end of the current flow after the execution in S104 described above, the risk monitoring block 140 of the first vehicle 2a may perform the common recognition with the second vehicle 2b by executing the acquisition determination processing of the warning information Iw according to S115.

As illustrated in FIG. 16, when the risk monitoring block 140 of the first vehicle 2a determines in S101 that the other road user 3 other than the second vehicle 2b is not recognized in the monitoring range of the first vehicle 2a, the current flow for the first vehicle 2a is transitioned to S105.

In S105, the risk monitoring block 140 of the first vehicle 2a executes processing of reversely replacing the first vehicle 2a and the second vehicle 2b in the description of S115 as the acquisition determination processing of the warning information Iw. Therefore, when the risk monitoring block 140 of the first vehicle 2a determines in S105 that the warning information Iw is not acquired, the current flow for the first vehicle 2a is ended.

On the other hand, when the risk monitoring block 140 of the first vehicle 2a determines in S105 that the warning information Iw is acquired, the current flow for the first vehicle 2a is sequentially transitioned to S106 and S107. That is, S106 and S107 are executed in response to the acquisition of the warning information Iw in real time when the other road user 3, which is a violation target, is not detected in the first vehicle 2a, even though the envelope violation with respect to the other road user 3 other than the first vehicle 2a is recognized in the second vehicle 2b, as illustrated in FIGS. 14 and 15.

As illustrated in FIG. 16, in S106, the risk monitoring block 140 of the first vehicle 2a executes processing of reversely replacing the first vehicle 2a and the second vehicle 2b in the description of S116 as processing of storing the warning information Iw. In S107, the risk monitoring block 140 of the first vehicle 2a executes processing of reversely replacing the first vehicle 2a and the second vehicle 2b in the description of S117 as processing of determining the envelope violation.

In the first vehicle 2a, when the other road user 3 which is not detected is entirely outside the range of the extended envelope Ee and outside the range of the model envelope Em as illustrated in FIG. 14, the envelope violation is not recognized. Therefore, when the risk monitoring block 140 of the first vehicle 2a determines in S107 that there is no envelope violation, the current flow for the first vehicle 2a is ended.

On the other hand, in the first vehicle 2a, when the other road user 3 which is not detected is at least partially inside the range of the extended envelope Ee and outside the range of the model envelope Em as illustrated in FIG. 15, the extended envelope violation as the envelope violation is recognized. Although not illustrated, in the first vehicle 2a, when the other road user 3 which is not detected is at least partially inside the range of the model envelope Em and inside the range of the extended envelope Ee, the model envelope violation as the envelope violation is recognized. For the recognition, information on the other road user 3, which is the violation target in the second vehicle 2b, may be added to the warning information Iw as the situation information Is or particularly as the envelope information Ise. The information on the other road user 3, which is the violation target in the second vehicle 2b, may be acquired from, for example, a remote center through the communication system 6 of the first vehicle 2a.

Therefore, when the risk monitoring block 140 of the first vehicle 2a determines in S107 that there is any one of the model envelope violation and the extended model violation, the current flow for the first vehicle 2a is transitioned to S108. In S108, the risk monitoring block 140 of the first vehicle 2a executes processing of reversely replacing the first vehicle 2a and the second vehicle 2b in the description of S118 as constraint setting processing. When the execution in S108 is ended, the current flow for the first vehicle 2a is ended.

As described above, according to the viewpoint of the first vehicle 2a in the first embodiment, in the first vehicle 2a serving as the host moving object, the envelope that is a violation of a safety envelope in which the SOTIF is set with respect to the other road user 3 other than the second vehicle 2b as the target moving object is monitored. Therefore, when the envelope violation with respect to the other road user 3 is recognized, the first vehicle 2a generates the warning information Iw for warning of the envelope violation such that the warning information Iw is transmitted to the second vehicle 2b. Accordingly, since the envelope violation with respect to the other road user 3 warned by the first vehicle 2a can be commonly recognized in the second vehicle 2b, it is possible to promote improvement of a response capability with respect to the other road user.

On the other hand, according to the viewpoint of the second vehicle 2b in the first embodiment, in the second vehicle 2b serving as the host moving object, the warning information Iw for warning of the envelope violation that is the violation of the safety envelope in which the SOTIF is set with respect to the other road user other than the second vehicle 2b in the first vehicle 2a serving as the target moving object is acquired from the first vehicle 2a. Therefore, in response to the acquisition of the warning information Iw, in the second vehicle 2b, the presence or absence of the envelope violation with respect to the other road user 3 is determined. Accordingly, since the envelope violation with respect to the other road user 3 warned by the first vehicle 2a can be commonly recognized in the second vehicle 2b and can be reflected in the determination on presence or absence of the envelope violation, it is possible to promote the improvement of the response capability with respect to the other road user.

According to the viewpoint of the second vehicle 2b in the first embodiment, in the second vehicle 2b serving as the host moving object, an envelope violation that is a violation of the safety envelope in which the SOTIF is set with respect to the other road user 3 other than the first vehicle 2a serving as the target moving object is monitored. Therefore, when the envelope violation with respect to the other road user 3 is recognized, the second vehicle 2b generates the warning information Iw for warning of the envelope violation such that the warning information Iw is transmitted to the first vehicle 2a. Accordingly, since the envelope violation with respect to the other road user 3 warned by the second vehicle 2b can be commonly recognized in the first vehicle 2a, it is possible to promote the improvement of the response capability with respect to the other road user.

On the other hand, according to the viewpoint of the first vehicle 2a in the first embodiment, in the first vehicle 2a serving as the host moving object, the warning information Iw for warning of the envelope violation that is the violation of the safety envelope in which the SOTIF is set with respect to the other road user other than the first vehicle 2a in the second vehicle 2b serving as the target moving object is acquired from the second vehicle 2b. Therefore, in response to the acquisition of the warning information Iw, in the first vehicle 2a, the presence or absence of the envelope violation with respect to the other road user 3 is determined. Accordingly, since the envelope violation with respect to the other road user 3 warned by the second vehicle 2b can be commonly recognized in the first vehicle 2a and can be reflected in the determination on presence or absence of the envelope violation, it is possible to promote the improvement of the response capability with respect to the other road user.

### Second Embodiment

A second embodiment is a modification of the first embodiment.

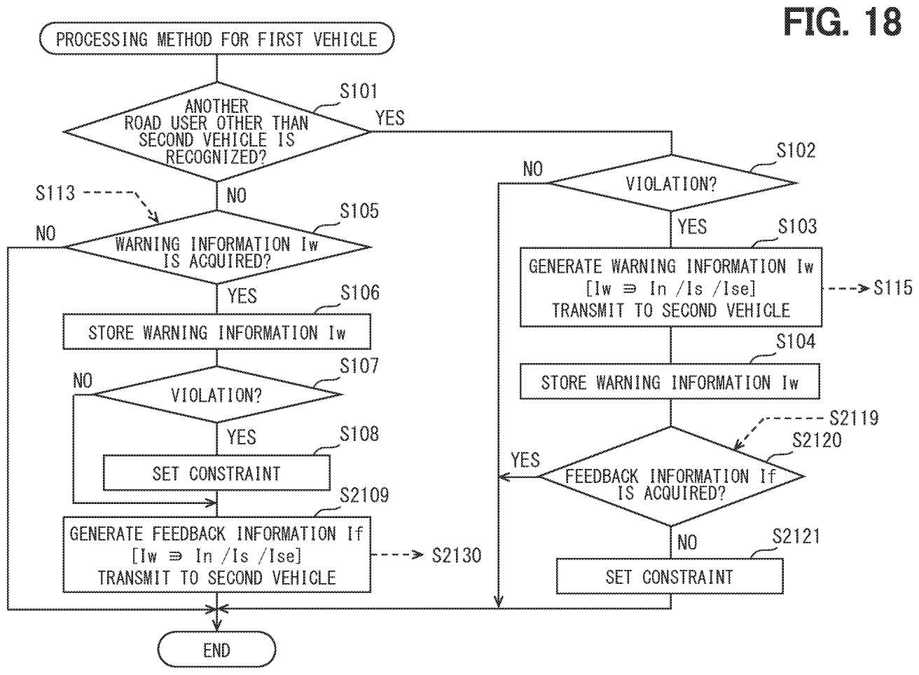

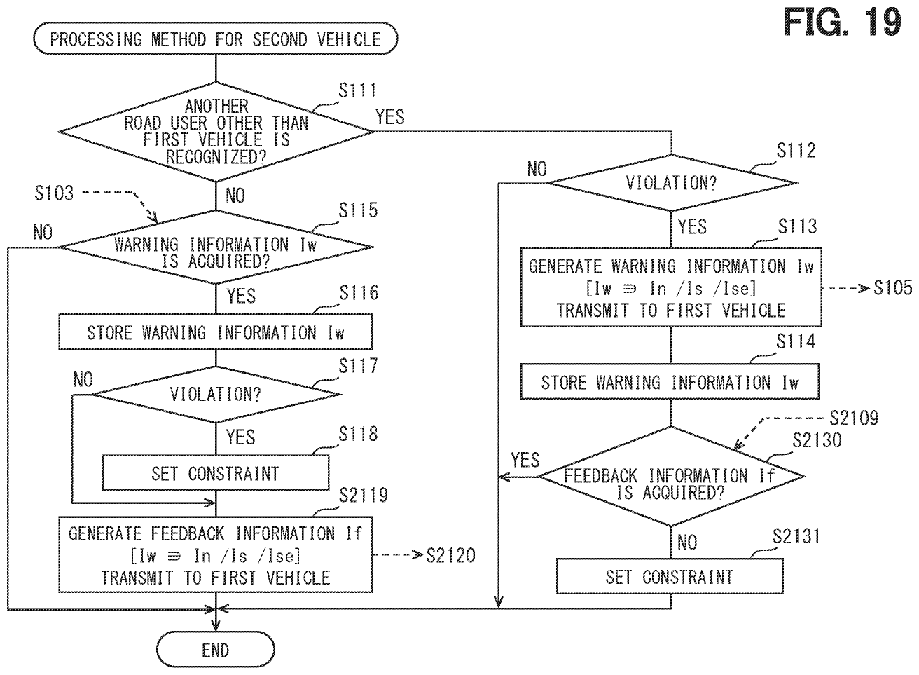

In a processing method according to the second embodiment in which the first vehicle 2a and the second vehicle 2b are illustrated in FIGS. 18 and 19 respectively, the execution in S100 and S110 is omitted. Accordingly, in the processing method, S2109, S2120, and S2121 for the first vehicle 2a and S2119, S2130, and S2131 for the second vehicle 2b are added.

As illustrated in FIG. 19, after it is determined in S117 that there is no envelope violation and after the execution in S118, the risk monitoring block 140 of the second vehicle 2b generates feedback information If for feeding back acquisition of the warning information Iw to the first vehicle 2a in S2119. The feedback information If may include notification information In for pushing notification from the second vehicle 2b to the first vehicle 2a about the acquisition of the warning information Iw. The feedback information If may be combined information in which the situation information Is obtained by reversely replacing the first vehicle 2a and the second vehicle 2b in the description of S103 is added to the notification information In. That is, the situation information Is may include the envelope information Ise related to a safety envelope set in the second vehicle 2b.

The warning information Iw generated in S2119 can be transmitted from the second vehicle 2b to the first vehicle 2a according to control of the communication system 6 by the risk monitoring block 140 of the second vehicle 2b. In other words, the risk monitoring block 140 of the second vehicle 2b generates the feedback information If for the warning information Iw such that the feedback information If is transmitted in real time from the second vehicle 2b to the first vehicle 2a in response to the acquisition of the warning information Iw. When the execution in S2119 is ended, the current flow for the second vehicle 2b is ended.

As illustrated in FIG. 18, in S2120 following S104, the risk monitoring block 140 of the first vehicle 2a determines whether the feedback information If from the second vehicle 2b is acquired by receiving via the communication system 6 of the first vehicle 2a within a set time from the transmission of the warning information Iw. When the risk monitoring block 140 of the first vehicle 2a determines in S2120 that the feedback information If is acquired, the current flow for the first vehicle 2a is ended.

Through such step S2120, the risk monitoring block 140 of the first vehicle 2a can check that common recognition with the second vehicle 2b is executed. In S2120, the risk monitoring block 140 of the first vehicle 2a may, in response to the acquisition of the feedback information If, delete the warning information Iw corresponding to the acquisition from the memory 10 of the first vehicle 2a. Alternatively, in S2120, the risk monitoring block 140 of the first vehicle 2a may store, in the memory 10 of the first vehicle 2a, the feedback information If acquired corresponding to the warning information Iw in S104.

On the other hand, when the risk monitoring block 140 of the first vehicle 2a determines in S2120 that the feedback information If is not acquired, the current flow for the first vehicle 2a is transitioned to S2121. In S2121, the risk monitoring block 140 of the first vehicle 2a sets a constraint on motion control of the first vehicle 2a to avoid an unreasonable risk to the possibility that the other road user 3, which is a violation target, is not detected in the second vehicle 2b or an envelope violation of the other road user 3 is not recognized in the second vehicle 2b. The constraint for avoiding the risk may be a limit command to the control block 160 of the first vehicle 2a, which gives a constraint for transitioning the first vehicle 2a to a minimal risk condition. The constraint for avoiding the risk may be a minor constraint of at least one of limiting a speed of the first vehicle 2a, limiting an acceleration of the first vehicle 2a, and keeping the first vehicle 2a away from the second vehicle 2b. In such constraint setting processing, when the first vehicle 2a cannot acquire the feedback information If for the transmission of the warning information Iw from itself due to factors such as the processing system 1 not being applied to the second vehicle 2b or the communication system 6 not being mounted on the second vehicle 2b, a more safer risk avoidance action is possible. When the execution in S2121 is ended, the current flow for the first vehicle 2a is ended. In the first vehicle 2a in which the current flow is ended without acquiring the feedback information If, the generation and transmission of the warning information Iw are repeated in S103 of a next flow when the envelope violation continues even in S102 in the next flow.

A case where the second vehicle 2b is a transmission side of the feedback information If and the first vehicle 2a is a receiving side of the feedback information If has been described. Next, a case where the first vehicle 2a is the transmission side of the feedback information If and the second vehicle 2b is the receiving side of the feedback information If will be described.

As illustrated in FIG. 18, after it is determined in S107 that there is no envelope violation and after the execution in S108, in S2109, the risk monitoring block 140 of the first vehicle 2a executes processing of reversely replacing the first vehicle 2a and the second vehicle 2b in the description of S2119 as the processing of generating the feedback information If. When the execution in S2109 is ended, the current flow for the first vehicle 2a is ended.

As illustrated in FIG. 19, in S2130 following S114, the risk monitoring block 140 of the second vehicle 2b executes processing of reversely replacing the first vehicle 2a and the second vehicle 2b in the description of S2120 as acquisition determination processing of the feedback information If. When the risk monitoring block 140 of the second vehicle 2b determines in S2130 that the feedback information If is acquired, the current flow for the second vehicle 2b is ended.

In such step S2130, the risk monitoring block 140 of the second vehicle 2b can check that common recognition with the first vehicle 2a is executed. In S2130, the risk monitoring block 140 of the second vehicle 2b may, in response to the acquisition of the feedback information If, delete the warning information Iw corresponding to the acquisition from the memory 10 of the second vehicle 2b. Alternatively, in S2130, the risk monitoring block 140 of the second vehicle 2b may store, in the memory 10 of the second vehicle 2b, the feedback information If acquired in correspondence with the warning information Iw in S114.

On the other hand, when the risk monitoring block 140 of the second vehicle 2b determines in S2130 that the feedback information If is not acquired, the current flow for the second vehicle 2b is transitioned to S2131. In S2131, the risk monitoring block 140 of the second vehicle 2b executes processing of reversely replacing the first vehicle 2a and the second vehicle 2b in the description of S2121 as the constraint setting processing for avoiding the risk to the possibility that the other road user 3, which is the violation target, is not detected in the first vehicle 2a or the envelope violation of the other road user 3 is not recognized in the first vehicle 2a. In such constraint setting processing, when the second vehicle 2b cannot acquire the feedback information If for the transmission of the warning information Iw from itself due to factors such as the processing system 1 not being applied to the first vehicle 2a or the communication system 6 not being mounted on the first vehicle 2a, a more safer risk avoidance action is possible. When the execution in S2131 is ended, the current flow for the second vehicle 2b is ended. In the second vehicle 2b in which the current flow is ended without acquiring the feedback information If, the generation and transmission of the warning information Iw are repeated in S113 of a next flow when the envelope violation continues even in S112 in the next flow.

In such a second embodiment, the added processing method obtained by adding S2109, S2120, and S2121, or S2119, S2130, and S2131 to the first embodiment is executed mainly by the risk monitoring block 140 of the first vehicle 2a or the second vehicle 2b. Therefore, it is possible to promote improvement of a response capability with respect to the other road user.

### Third Embodiment

A third embodiment is another modification of the first embodiment.

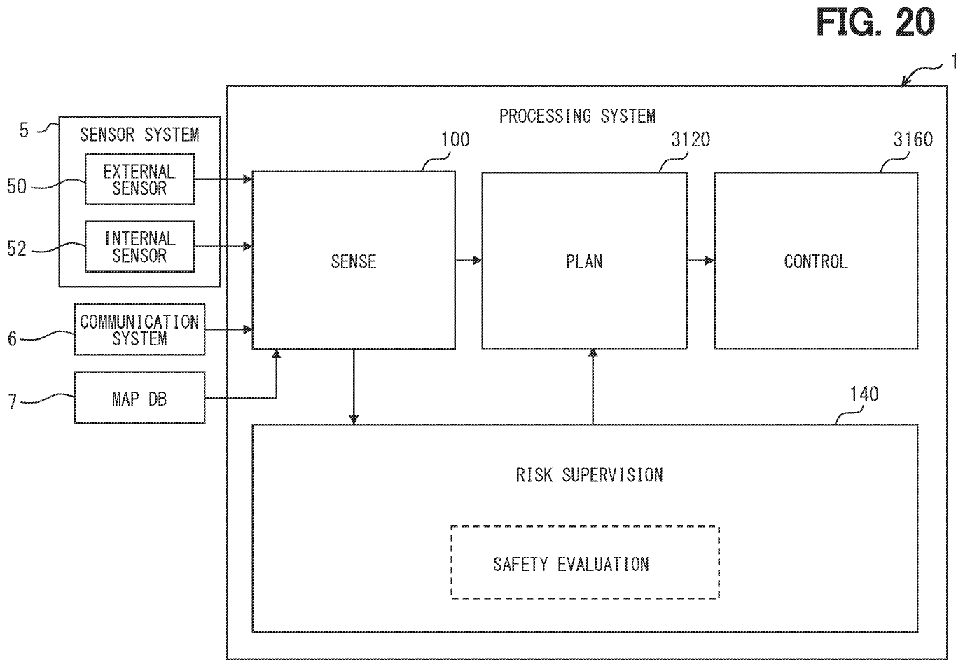

As illustrated in FIG. 20, in a control block 3160 in the third embodiment, the processing of acquiring the determination information related to the safety envelope from the risk monitoring block 140 is omitted. Therefore, a planning block 3120 in the third embodiment acquires the determination information related to the safety envelope from the risk monitoring block 140. The planning block 3120 plans driving control of the vehicle 2 according to the planning block 120 when the determination information indicating that there is no envelope violation is acquired. On the other hand, when the determination information indicating that there is an envelope violation is acquired, the planning block 3120 gives a constraint based on the determination information for the driving control at the stage of planning the driving control according to the planning block 120. That is, the planning block 3120 limits the driving control to be planned. In either case, the control block 3160 executes the driving control of the vehicle 2 planned by the planning block 3120.

In such a third embodiment, the processing method according to the first embodiment is executed mainly by the risk monitoring blocks 140 of the first vehicle 2a and the second vehicle 2b. Therefore, it is possible to promote improvement of a response capability with respect to the other road user. The third embodiment may be combined with the second embodiment.

### Fourth Embodiment

A fourth embodiment is a modification of the third embodiment.

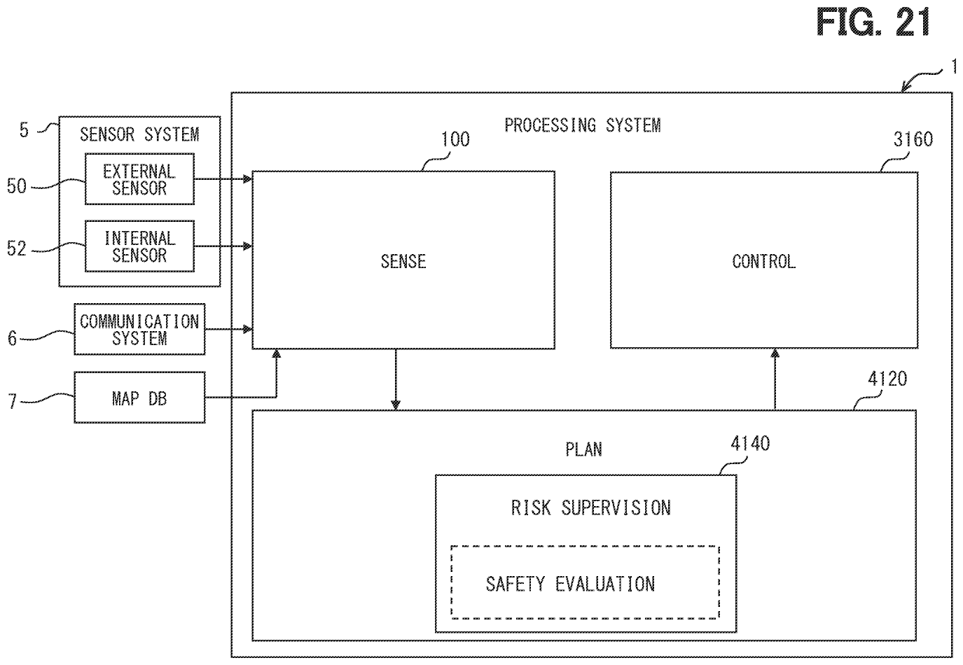

As illustrated in FIG. 21, in a planning block 4120 in the fourth embodiment, a function of the risk monitoring block 140 is taken in as a risk monitoring sub-block 4140. When determination information indicating that there is no envelope violation is acquired by the risk monitoring sub-block 4140, the planning block 4120 plans driving control of the vehicle 2 according to the planning block 120. On the other hand, when determination information indicating that there is an envelope violation is acquired by the risk monitoring sub-block 4140, the planning block 4120 gives a constraint based on the determination information for the driving control at the stage of planning the driving control according to the planning block 120. That is, the planning block 4120 limits the driving control to be planned. In either case, the control block 3160 executes the driving control of the vehicle 2 planned by the planning block 4120.

In such a fourth embodiment, the processing method according to the first embodiment is executed mainly by the risk monitoring sub-blocks 4140 of the first vehicle 2a and the second vehicle 2b. Therefore, it is possible to promote improvement of a response capability with respect to the other road user. The fourth embodiment may be combined with the second embodiment.

### Fifth Embodiment

A fifth embodiment is a modification of the first embodiment.

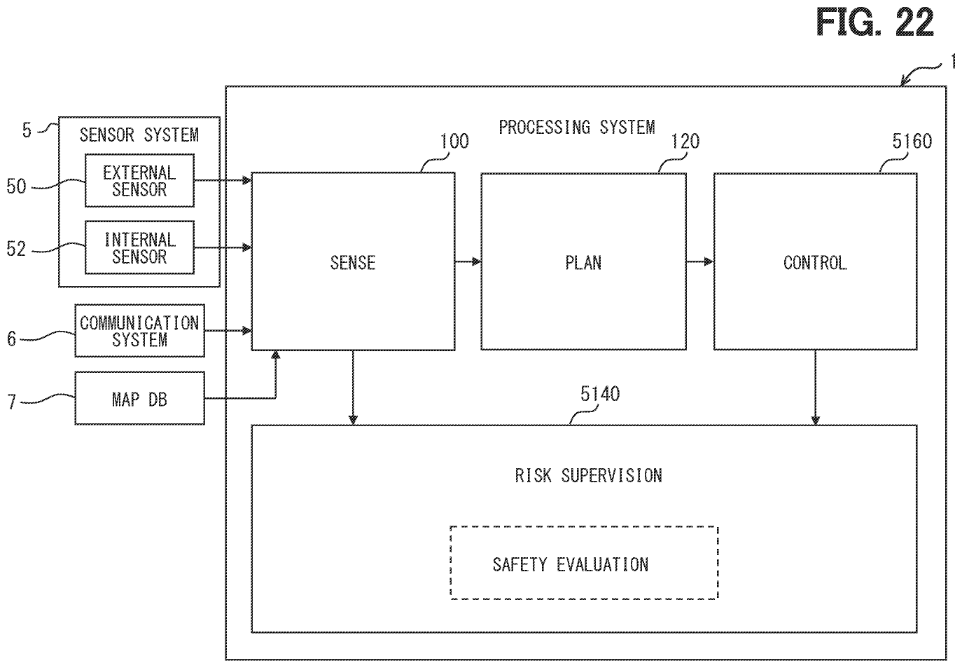

As illustrated in FIG. 22, in a control block 5160 in the fifth embodiment, the processing of acquiring the determination information related to the safety envelope from a risk monitoring block 5140 is omitted. Therefore, the risk monitoring block 5140 in the fourth embodiment acquires information indicating a result of driving control executed by the control block 5160 for the vehicle 2. The risk monitoring block 5140 evaluates the driving control by executing determination of an envelope violation on the result of the driving control.

In such a fifth embodiment, the processing method according to the first embodiment is executed mainly by the risk monitoring blocks 5140 of the first vehicle 2a and the second vehicle 2b. Therefore, it is possible to promote improvement of a response capability with respect to the other road user. The fifth embodiment may be combined with the second embodiment. When the fifth embodiment is combined with the second embodiment, in S2121 and S2131, evaluation of the driving control based on a set constraint is executed.

### Sixth Embodiment

A sixth embodiment is a modification of the first embodiment.

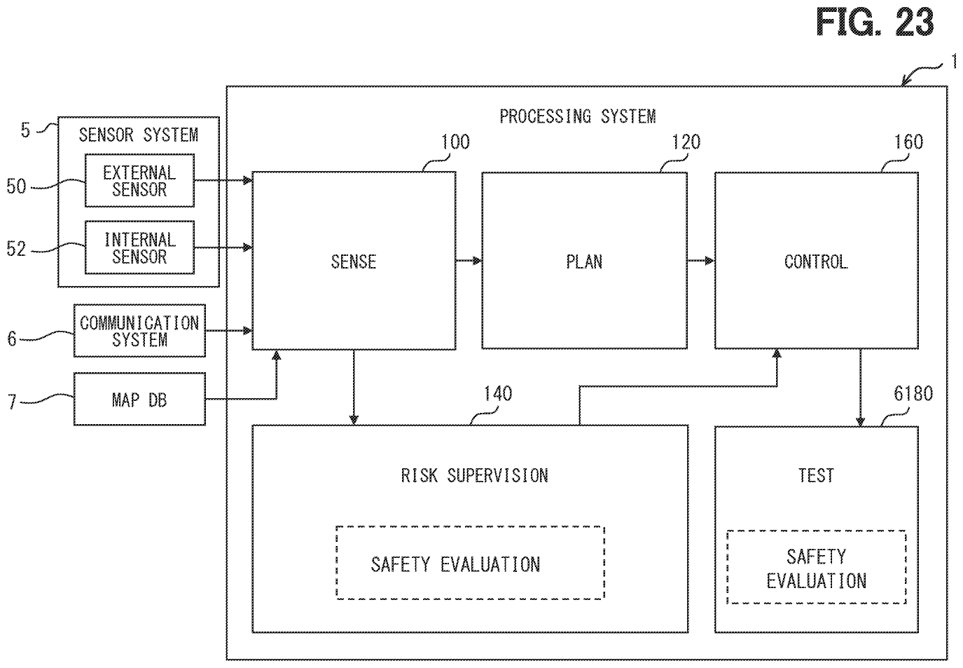

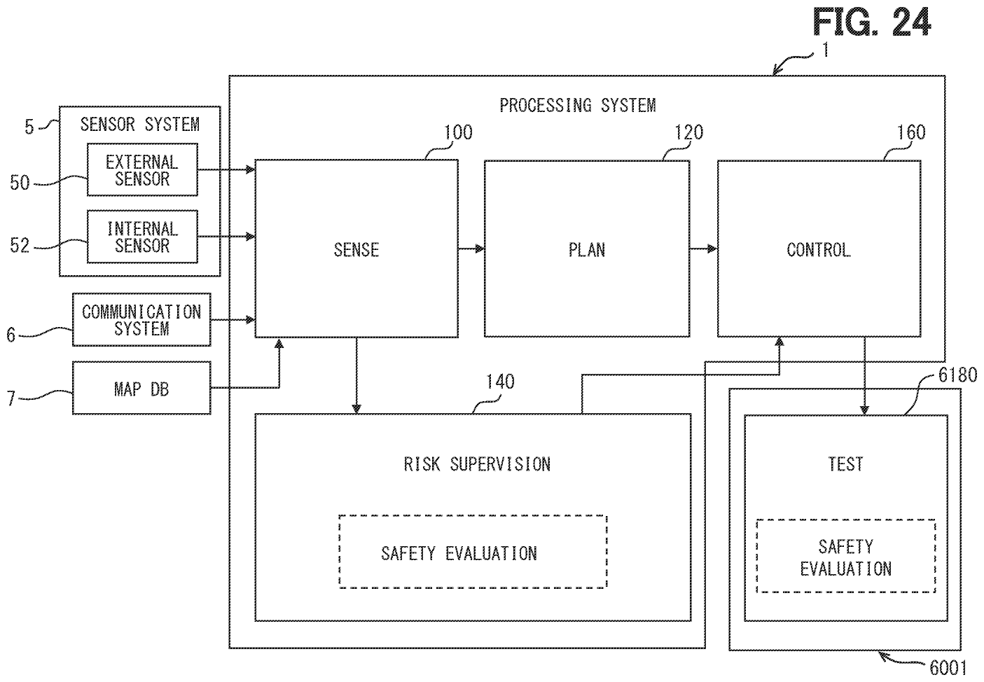

As illustrated in FIGS. 23 and 24, in the sixth embodiment, a test block 6180 for testing the driving control by the control block 160 for, for example, safety permission or the like is added. Functions equivalent to the detection block 100 and the risk monitoring block 140 are given to the test block 6180. The test block 6180 may be constructed by the processing system 1 illustrated in FIG. 23 executing a test program added to a processing program for constructing each of the blocks 100, 120, 140, and 160. The test block 6180 may be constructed by a test processing system 6001 different from the processing system 1 illustrated in FIG. 24 executing a test processing program different from the processing program for constructing each of the blocks 100, 120, 140, and 160. The test processing system 6001 may include at least one dedicated computer including the memory 10 and the processor 12, which are connected to the processing system 1 (not illustrated in a case of connection via the communication system 6) in order to test the driving control.

In such a sixth embodiment, the processing method according to the first embodiment is executed mainly by the test blocks 6180 of the first vehicle 2a and the second vehicle 2b. Therefore, it is possible to promote improvement of a response capability with respect to the other road user. The sixth embodiment may be combined with the second embodiment. When the sixth embodiment is combined with the second embodiment, in S2121 and S2131, evaluation of the driving control as a test is executed based on a set constraint.

### OTHER EMBODIMENTS

Although the multiple embodiments have been described above, the present disclosure is not construed as being limited to these embodiments, and can be applied to various embodiments and combinations within a scope that does not depart from the spirit of the present disclosure.

In the modifications, the dedicated computer constituting the processing system 1 may include at least one of a digital circuit and an analog circuit as a processor. The digital circuit is at least one of, for example, an application specific integrated circuit (ASIC), a field programmable gate array (FPGA), a system on a chip (SOC), a programmable gate array (PGA), and a complex programmable logic device (CPLD). Such a digital circuit may include a memory storing a program.

In S102, S107, S112, and S117 in the processing methods in the modifications, the presence or absence of the envelope violation may be determined only on one of the model envelope Em and the extended envelope Ee as the safety envelope. In the processing methods in this case, the monitoring range of the safety envelope may be set in the range including the model envelope Em or the extended envelope Ee, which is a determination target of the envelope violation in S101 and S110.

In the processing methods in the modifications, the processing of storing the warning information Iw in S104 and S114 may be omitted. In the processing methods in the modifications, the processing of storing the warning information Iw in S106 and S116 may be omitted. In the processing methods in the modifications, the mutual authentication processing in S100 and S110 may be omitted in the first embodiment according to the second embodiment.

1. A processing method executed by a processor to perform processing related to driving of a host moving object that is configured to communicate with a target moving object, the processing method comprising:
monitoring an envelope violation that is a violation of a safety envelope in which safety of intended functionality is set in the host moving object with respect to another road user other than the target moving object; and
generating, when the envelope violation is recognized in the host moving object, warning information for warning of the envelope violation that is to be transmitted to the target moving object.

2. The processing method according to claim 1, wherein
monitoring the envelope violation further includes monitoring the envelope violation with respect to a model envelope as the safety envelope, and
the model envelope is based on a safety model that is defined by modeling the safety of the intended functionality.

3. The processing method according to claim 1, wherein
monitoring the envelope violation further includes monitoring the envelope violation with respect to an extended envelope, and
the extended envelope is defined by adding a physics-based margin to the safety envelope that is based on a safety model defined by modeling the safety of the intended functionality.

4. The processing method according to claim 1, wherein
generating the warning information further includes generating the warning information for pushing notification about the envelope violation to the target moving object.

5. The processing method according to claim 1, wherein
generating the warning information further includes generating the warning information to which envelope information related to the safety envelope set in the host moving object is added.

6. The processing method according to claim 1, further comprising:
storing the generated warning information.

7. The processing method according to claim 1, further comprising:
acquiring feedback information for giving feedback regarding acquisition of the warning information from the target moving object.

8. The processing method according to claim 7, further comprising:
setting a constraint or restriction on the host moving object when the feedback information is not acquired.

9. A processing system that performs processing related to driving of a host moving object configured to communicate with a target moving object, the processing system comprising a processor configured to:
monitor an envelope violation that is a violation of a safety envelope in which safety of intended functionality is set in the host moving object with respect to another road user other than the target moving object; and
generate, when the envelope violation is recognized in the host moving object, warning information for warning of the envelope violation that is to be transmitted to the target moving object.

10. A non-transitory, computer readable, tangible storage medium storing a processing program, the processing program comprising an instruction, when executed by a processor, causing the processor to perform processing related to driving of a host moving object that is configured to communicate with a target moving object, the instruction comprising:
monitoring an envelope violation that is a violation of a safety envelope in which safety of intended functionality is set in the host moving object with respect to another road user other than the target moving object; and
generating, when the envelope violation is recognized in the host moving object, warning information for warning of the envelope violation that is to be transmitted to the target moving object.

11. A processing method executed by a processor to perform processing related to driving of a host moving object that is configured to communicate with a target moving object, the processing method comprising:
acquiring, from the target moving object, warning information for warning of an envelope violation that is a violation of a safety envelope in which safety of intended functionality is set in the target moving object with respect to another road user other than the host moving object; and
determining whether the envelope violation with respect to the other road user occurs in response to acquiring the warning information.

12. The processing method according to claim 11, wherein
determining whether the envelope violation occurs further includes determining whether the envelope violation with respect to a model envelope as the safety envelope occurs, and
the model envelope is based on a safety model that is defined by modeling the safety of the intended functionality.

13. The processing method according to claim 11, wherein
determining whether the envelope violation occurs further includes determining whether the envelope violation with respect to an extended envelope occurs, and
the extended envelope is defined by adding a physics-based margin to the safety envelope that is based on a safety model defined by modeling the safety of the intended functionality.

14. The processing method according to claim 11, wherein
determining whether the envelope violation occurs further includes determining whether the envelope violation with respect to the other road user occurs in response to acquiring the warning information when the other road user is not detected in the host moving object.

15. The processing method according to claim 11, wherein
acquiring the warning information further includes acquiring, from the target moving object, the warning information for pushing notification about the envelope violation.

16. The processing method according to claim 11, wherein
acquiring the warning information further includes acquiring the warning information to which envelope information related to the safety envelope set in the target moving object is added.

17. The processing method according to claim 11, further comprising:
storing the acquired warning information.

18. The processing method according to claim 11, further comprising:
generating feedback information for giving feedback regarding acquisition of the warning information to the target moving object.

19. A processing system that performs processing related to driving of a host moving object configured to communicate with a target moving object, the processing system comprising a processor configured to:
acquire, from the target moving object, warning information for warning of an envelope violation that is a violation of a safety envelope in which safety of intended functionality is set in the target moving object with respect to another road user other than the host moving object; and
determine whether the envelope violation with respect to the other road user occurs in response to acquiring the warning information.

20. A non-transitory, computer readable, tangible storage medium storing a processing program, the processing program comprising an instruction, when executed by a processor, causing the processor to perform processing related to driving of a host moving object that is configured to communicate with a target moving object, the instruction comprising:
acquiring, from the target moving object, warning information for warning of an envelope violation that is a violation of a safety envelope in which safety of intended functionality is set in the target moving object with respect to another road user other than the host moving object; and
determining whether the envelope violation with respect to the other road user occurs in response to acquiring the warning information.
